(19) United States
(12) Patent Application Publication
(10) Pub. No.: US 2020/0167699 A1
(43) Pub. Date: May 28, 2020

(54) EVENT MANAGEMENT AND COORDINATION PLATFORM

(71) Applicant: Tickitin Experiences LLC, Brooklyn, NY (US)

(72) Inventor: Eli Cohen, Brooklyn, NY (US)

(73) Assignee: Tickitin Experiences LLC, Brooklyn, NY (US)

(21) Appl. No.: 16/441,826

(22) Filed: Jun. 14, 2019

Related U.S. Application Data
(60) Provisional application No. 62/771,363, filed on Nov. 26, 2018.

(51) Int. Cl. G06Q 10/02; G06Q 20/04; H04L 12/58

(52) U.S. Cl. CPC G06Q 10/02; H04L 51/046; G06Q 20/045

(57) ABSTRACT

Systems and methods for group event and service coordination are provided, including Smart Chats, which connect user accounts to tools for intelligently finding tickets for sale, cost splitting, accessing related events and services, and sharing media. The systems and methods further implement artificial intelligence to match non-connected user accounts and provide event and service recommendations to connected user accounts.

### CROSS REFERENCES TO RELATED APPLICATIONS

This application is related to and claims priority from the following US patents and patent applications. This application claims the benefit of U.S. Provisional Application No. 62/771,363, filed Nov. 26, 2018, which is incorporated herein by reference in its entirety.

### BACKGROUND OF THE INVENTION

### 1. Field of the Invention

The present invention relates to systems and methods for group event coordination and communication, and more specifically relates to social networking platforms that allow for communication, invitation, and collaboration related to live events and social gatherings.

### 2. Description of the Prior Art

It is generally known in the prior art to provide social networking systems that allow users to add contacts to a “friends” list, view contact activity in an activity feed, create event organization pages and send invitations to the events, see lists of public attendees that have responded to events, and communicate with one or more contacts via a message board, forum, or messenger. However, while these networks may provide for communication between event participants, the structure of these networks does not provide for an efficient manner of identifying and connecting accounts that have a likelihood of attending the event together.

It is further generally known in the prior art to provide ticketing systems that allow users to view, reserve, and purchase events to a ticket. Reserved seats are often held for a set time period before being released back to the public. While some group ticketing systems have been implemented with split-fare features, these systems often do not provide any methods for efficiently coordinating events between group participants, do not generate user behavior analytics, and do not provide relevant social tools and recommendations.

Prior art patent documents include the following:

US Publication No. 20130085790 for Organization of Group Attended Ticket Events by inventors Palmer et al., filed Sep. 28, 2012 and published Apr. 4, 2013, is directed to computing systems and methods for organizing group attended ticketed events. A computing system includes one or more memory device or storage components adapted to store user information regarding users of the computing system as well as event information regarding upcoming ticketed events, and one or more processors for conducting activities regarding ticketing for group members. Such activities include displaying information regarding a ticketed event, accepting a user input for inviting invitees to the ticketed event, communicating invitations to the invitees based on the input, receiving invitee response information from the invitees regarding interest in attending the ticketed event, and accepting a purchase request for tickets to the ticketed event from the user, wherein the purchase request is based at least in part on the invitee response information.

US Publication No. 20070066397 for System and method for event invitation by inventors Nammi et al., filed Sep. 20, 2005 and published Mar. 22, 2007, is directed to a computer-related system and computer-implemented method for coordinating attendance of an event. The method may begin at a host computer associated with a host by selecting an event from a plurality of events. The event associated with a special arrangement, such as a ticket or fee, for a attendance to the event. The, the host may send a notification to at least one computer associated with an invited guest about the reservation, the notification including an invitation to the event. The invited guest may then respond and in response to the invited guest accepting the invitation, a transaction for completing the special arrangement is invoked. For example, the ticket(s) to the event may be purchased.

US Publication No. 20120221362 for System and method for managing group ticket procurement by inventors Nezer et al., filed Feb. 24, 2011 and published Aug. 30, 2012, is directed to a business method that is a process for coordinating the sale of tickets to groups of people who want to sit together at the event, but pay for their tickets separately. Specifically, the invention is a method of providing group tickets to an event of interest, comprising selecting an event of interest; screening an inventory of seats for the event to create a list of available tickets; choosing from the list, tickets that meet a set of predetermined criteria; and processing the purchase of one or more group tickets by each group member, using information supplied by said group member.

US Publication No. 20150339596 for Apparatus and Methods of Recommending Multiple Options to a Group of Remote Users and Forming an Agreement by inventors Ioannidis et al., filed Jun. 21, 2013 and published Nov. 26, 2015, is directed to methods and apparatus for a system providing group recommendations, event scheduling, and forming consensus agreements among a group of disparately located users are provided by the present principles. Communication among the disparately located users may be achieved through social media tools, online polling, chatting, and texting. The methods and apparatus allow a user profile to be constructed based on ratings that a user provides to items in a database. The items may comprise such things as restaurants, movie theaters, or other entertainment and group activities. The items may comprise feature vectors including attributes of the individual items. With user profiles constructed, the methods and apparatus may allow prediction of a rating that an individual with a particular user profile may give to a similar item in a database. The system may be used to predict the best choice for a group activity by considering the ratings of all users within a group. Individual ratings may be weighted to give higher or lower priority to some users. The system may also recommend activities based on the users participating in the group, or allow the users to select other activities to be considered. In one exemplary embodiment, the system selects recommendations for the users, comprising elements such as movie title, theater location, seating, and prices. The system sends notifications to the users, collects preferences from the users, and determines a choice based on the collected preferences. The users are notified of the choice and given an opportunity to purchase tickets electronically. If so, they may receive electronic tickets, coupons, promotions, or offers.

U.S. Pat. No. 9,349,108 for Automated, conditional event ticketing and reservation techniques implemented over a computer network by inventors Skeen et al., filed Dec. 21, 2015 and issued May 24, 2016, is directed to various techniques are described herein for providing ticketing reservation and purchasing functionality for enabling and/or facilitating users in performing activities/operations relating to group ticket reservations and/or automated conditional ticket purchases for various types of events which are scheduled to occur at one or more different venues.

U.S. Pat. No. 10,043,142 for Collaborative system with personalized user interface for organizing group outings to events by inventors Palej a et al., filed Mar. 10, 2017 and issued Aug. 7, 2018, is directed to features are disclosed relating to a collaborative ticketing system that manages various aspects of ticketing for events (e.g., movies, concerts, sporting events, and the like) using knowledge about the contacts of system users. The collaborative ticketing system includes a mobile application that includes a personalized user interface through which users can identify movies or other events to attend at specific venues. The mobile application provides functionality for users to publish information to their contacts about the events they want to attend, and to arrange group outings to selected events.

US Publication No. 20160019472 for System and method for organizing a group activity for multiple paying parties by inventor Javit, filed Jul. 16, 2014 and published Jan. 21, 2016, is directed to a computer implemented system and method for organizing a group activity for multiple paying parties. Venues can offer group activities and participation in the events may be organized by a host user according to terms defined by the host. The terms may include a fee splitting arrangement dividing the cost of the group activity between proposed participants. The terms may be communicated to invitees who can agree to the fee splitting arrangement. An activity may be reserved with the venue when all parties have agreed to the fee splitting arrangement and the fee has been collected.

US Publication No. 20130317893 for System and method for coordinating event participation and payment by inventors Nelson et al., filed May 23, 2013 and published Nov. 28, 2013, is directed to systems and methods for coordinating participation in, and payment for, events. In particular, the invention allows a person to initiate a group event without exposing themselves to a full cost of the event, even where full payment is traditionally collected through a single bill or prior to the event. In some aspects, the invention provides a method of organizing an event that includes broadcasting information about an event to potential participants, receiving a commitment to pay from participants, and charging each participant their share while paying a full event cost, so that no one person must pay the full cost.

### SUMMARY OF THE INVENTION

The present invention relates to social networking for organizing group events and services. Specifically, the invention is directed to communication, organization, ticket purchasing, and media sharing for events via an online portal. Events and services include any kind of social gathering, entertainment event, or supporting service, such as a concert, theater production, party, or group dining experience as well as supporting transportation services, event food and drink vendors, or location amenities.

It is an object of this invention to improve the event organization systems of the prior art by introducing systems that provide for more group-centric features that reduce the amount of time, coordination, and money required to plan event outings. Further, the improvements of the present invention provide for improved digital event communication and organization platforms for attendance management and networking in order to promote audience affinity to and interaction during an event. As opposed to systems of the prior art, embodiments of the present invention improve computer technology for event management and coordination tools through the introduction of smart matching of user profiles, artificial intelligence-driven group ticketing and payment features, and connections between these systems and external ticketing, food, merchandise, or restaurant table management platforms.

In one embodiment, the present invention is directed to a system for coordinating event communication and ticketing, comprising: at least one server computer, including a memory with at least one database; an internet messaging platform; and wherein the at least one server computer is operable to manage an internal database of tickets or an external database of tickets; wherein the at least one server computer is in network communication with a plurality of devices; wherein the at least one server computer is operable to store a plurality of user profiles; wherein the at least one server computer is operable to provide to the plurality of devices an indication of upcoming live events; wherein the at least one server computer is operable to establish a group communication connection between a subset of the plurality of user profiles via the internet messaging platform; wherein the internet messaging platform is operable to assign an event to the group communication connection; wherein the internet messaging platform is operable to receive desired price ranges from the subset of the plurality of user profiles via the group communication connection; wherein the at least one server computer is operable to determine an available selection of tickets for the assigned event based on the desired price ranges; wherein the at least one server computer is operable to reserve and/or purchase the available selection of tickets; wherein the at least one server computer is operable to, upon reservation or purchase of the available selection of tickets, assign the tickets to the subset of the plurality of user profiles; and wherein the at least one server computer is operable to, upon assignment of the tickets to the subset of the plurality of user profiles, provide access to a second internet messaging platform for each of the subset of the plurality of user profiles.

In another embodiment, the present invention is directed to a method for coordinating event communication and ticketing, comprising: providing at least one server in network communication with a plurality of devices; storing a plurality of user profiles on the at least one server; providing to the plurality of devices an indication of upcoming live events; establishing a group communication connection between a subset of the plurality of user profiles via an internet messaging platform; assigning an event to the group communication connection; receiving desired price ranges from the subset of the plurality of users via the group communication connection; determining an available selection of tickets for the assigned event based on the desired price ranges; and reserving and/or purchasing the available selection of tickets.

In a yet another embodiment, the present invention is directed to a system for coordinating event communication and ticketing, comprising: at least one server computer, including a memory with at least one database; an internet messaging platform; and wherein the at least one server computer is in network communication with a plurality of devices; wherein the at least one server computer is operable to store a plurality of user profiles; wherein the at least one server computer is operable to provide to the plurality of devices an indication of upcoming live events; wherein the at least one server computer is operable to establish a group communication connection between a subset of the plurality of user profiles via the internet messaging platform; wherein the internet messaging platform is operable to assign an event to the group communication connection; wherein the internet messaging platform is operable to receive desired price ranges from the subset of the plurality of users via the group communication connection; wherein at least one server computer is operable to determine an available selection of tickets for the assigned event based on the desired price ranges; and wherein the at least one server computer is operable to reserve and/or purchase the available selection of tickets.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates one embodiment of an event listing page according to the present invention.

FIG. 2 illustrates one embodiment of an event highlight page according to the present invention.

FIG. 3 illustrates one embodiment of an event detail page with social features and solo checkout according to the present invention.

FIG. 4 illustrates one embodiment of a participant listing page with social features according to the present invention.

FIG. 5 illustrates one embodiment of a Smart Chat initiation from connected profiles according to the present invention.

FIG. 6 illustrates one embodiment of a Smart Chat according to the present invention.

FIG. 7 illustrates one embodiment of price range sliders according to the present invention.

FIG. 8 illustrates one embodiment of Smart Chat ticket selection features according to the present invention.

FIG. 9 illustrates one embodiment of a Smart Chat invite feature according to the present invention.

FIG. 10 illustrates one embodiment of a solo price selection feature of the present invention.

FIG. 11 illustrates one embodiment of a solo ticket selection feature of the present invention.

FIG. 12 illustrates one embodiment of a Memory Wall according to the present invention.

FIG. 13 illustrates one embodiment of a profile detail page according to the present invention.

FIG. 14 illustrates one embodiment of a Smart Chat price range tool according to the present invention.

FIG. 15 illustrates one embodiment of Smart Chat seat recommendation functionality according to the present invention.

FIG. 16 is a schematic diagram of a cloud-based system of the present invention.

FIG. 17 illustrates one embodiment of a Smart Chat with a service add-on widget according the present invention.

FIG. 18 illustrates a Smart Chat with multiple event coordination tools, including services for a sporting event, according to one embodiment of the present invention.

FIG. 19 illustrates a Smart Chat with multiple event coordination tools, including services for a concert event, according to one embodiment of the present invention.

FIG. 20 illustrates a Smart Chat with multiple event coordination tools, including services for a restaurant reservation, according to one embodiment of the present invention.

FIG. 21 illustrates a rewards progress indicator according to one embodiment of the present invention.

FIG. 22 illustrates a Smart Chat with event attachment capabilities according to one embodiment of the present invention.

FIG. 23 illustrates a Smart Chat with supplemental service connections according to one embodiment of the present invention.

FIG. 24 is a flow chart illustrating a method for Platform reservations and/or purchases according to one embodiment of the present invention.

FIG. 25 illustrates a Smart Chat History with events associated with a user account according to one embodiment of the present invention.

FIG. 26 is a diagram illustrating supplemental services and purchase or reservation features for an event within the Platform according to one embodiment of the present invention.

FIG. 27 illustrates an event attendee filter according to one embodiment of the present invention.

FIG. 28 illustrates a Smart Chat with search functionality according to one embodiment of the present invention.

FIG. 29 illustrates a ticket query and response system between a Smart Chat and a Ticket/Reservation Database according to one embodiment of the present invention.

FIG. 30 illustrates a multi-ticket delivery method according to one embodiment of the present invention.

### DETAILED DESCRIPTION

The present invention is generally directed to a group event system. The invention generally includes systems and methods for coordination and communication between participants before, during, and after an event. The systems and methods of the present invention provide for improved account matching and discovery, service synthesis and communication, event security, and behavior analytics.

In one embodiment, the present invention is directed to a system for coordinating event communication and ticketing, comprising: at least one server computer, including a memory with at least one database; an internet messaging platform; and wherein the at least one server computer is operable to manage an internal database of tickets or an external database of tickets; wherein the at least one server computer is in network communication with a plurality of devices; wherein the at least one server computer is operable to store a plurality of user profiles; wherein the at least one server computer is operable to provide to the plurality of devices an indication of upcoming live events; wherein the at least one server computer is operable to establish a group communication connection between a subset of the plurality of user profiles via the internet messaging platform; wherein the internet messaging platform is operable to assign an event to the group communication connection; wherein the internet messaging platform is operable to receive desired price ranges from the subset of the plurality of user profiles via the group communication connection; wherein the at least one server computer is operable to determine an available selection of tickets for the assigned event based on the desired price ranges; wherein the at least one server computer is operable to reserve and/or purchase the available selection of tickets; wherein the at least one server computer is operable to, upon reservation or purchase of the available selection of tickets, assign the tickets to the subset of the plurality of user profiles; and wherein the at least one server computer is operable to, upon assignment of the tickets to the subset of the plurality of user profiles, provide access to a second internet messaging platform for each of the subset of the plurality of user profiles.

In another embodiment, the present invention is directed to a method for coordinating event communication and ticketing, comprising: providing at least one server in network communication with a plurality of devices; storing a plurality of user profiles on the at least one server; providing to the plurality of devices an indication of upcoming live events; establishing a group communication connection between a subset of the plurality of user profiles via an internet messaging platform; assigning an event to the group communication connection; receiving desired price ranges from the subset of the plurality of users via the group communication connection; determining an available selection of tickets for the assigned event based on the desired price ranges; and reserving and/or purchasing the available selection of tickets.

In a yet another embodiment, the present invention is directed to a system for coordinating event communication and ticketing, comprising: at least one server computer, including a memory with at least one database; an internet messaging platform; and wherein the at least one server computer is in network communication with a plurality of devices; wherein the at least one server computer is operable to store a plurality of user profiles; wherein the at least one server computer is operable to provide to the plurality of devices an indication of upcoming live events; wherein the at least one server computer is operable to establish a group communication connection between a subset of the plurality of user profiles via the internet messaging platform; wherein the internet messaging platform is operable to assign an event to the group communication connection; wherein the internet messaging platform is operable to receive desired price ranges from the subset of the plurality of users via the group communication connection; wherein at least one server computer is operable to determine an available selection of tickets for the assigned event based on the desired price ranges; and wherein the at least one server computer is operable to reserve and/or purchase the available selection of tickets.

None of the prior art discloses a group ticketing platform that includes event management and coordination features as well as price splitting and social discovery mechanisms. Additionally, none of the prior art includes the security and analytics embodiments of the present invention, which enable event participants, event hosts, and brokers to achieve a level of detail, security, and insight into event attendance that was heretofore unavailable.

Referring now to the drawings in general, the illustrations are for the purpose of describing one or more preferred embodiments of the invention and are not intended to limit the invention thereto.

The present invention is directed to systems and methods that improve event coordination, communication, and attendance management computer system functionality. Specifically, prior art systems have not provided a way to manage tickets and reservations in a seamless manner between multiple user accounts. Whereas prior art systems may include cost division tools, none of these systems provide the benefits of the present invention, including matching of user profiles to events and services as well as matching of user profiles to other user profiles. These improvements similarly improve user interaction with online ticketing systems, since many people wish to attend events and want to meet other people at the event, but they do not have anyone to go with. People may also not have an easy method for interacting and meeting other attendees at the event. The present invention solves this problem by improving upon event platforms of the prior art and providing tools that intelligently connect participants who wish to go to events, participants at events, and participants of a past event.

In one embodiment, a web-hosted platform (the “Platform”) is provided with at least one server and at least one memory including at least one database. The Platform is in network communication with one or more devices via the Internet and provides a graphical user interface (GUI) and serves markup or other user interface (UI), user experience (UX), or web protocol files to the one or more devices through which users are able to register, interact, communicate, and view other users' information.

The Platform is operable to receive information from a user via the Internet or other network, register the user with the system, and construct a user account and user profile, wherein the user profile is stored in the Platform database. The profile is digitally constructed to store information that describes the user and allows for matching between other user profiles. A web-based GUI prompts a user to input personal information, including name, date of birth, email address, location, music interests, event interests, academic institutions, occupation, and/or other group memberships. The Platform is further operable to store pictures, videos, audio clips, or other non-textual information with a profile for displaying on social pages of the Platform. Upon registration, the Platform is operable to automatically suggest upcoming events related to information contained in the user profile. The recommendation is based on at least one factor, for example an analysis of distance of the event location from a user location, an indicated fandom level, a number of friends or connected users that are attending an event, or a membership to a group that is hosting an event.

Events are, in one embodiment, public to view, but the attendee list is private. Based on a request to join an event from a user account, an associated user profile is added to the event, whereupon the Platform indicates to the user account a number of other user profiles with an indication of planned attendance the event or an indication of event interest. In another embodiment, a public event listing includes the number of participants with user profiles that have indications of interest in the event or indications of planned attendance at the event.

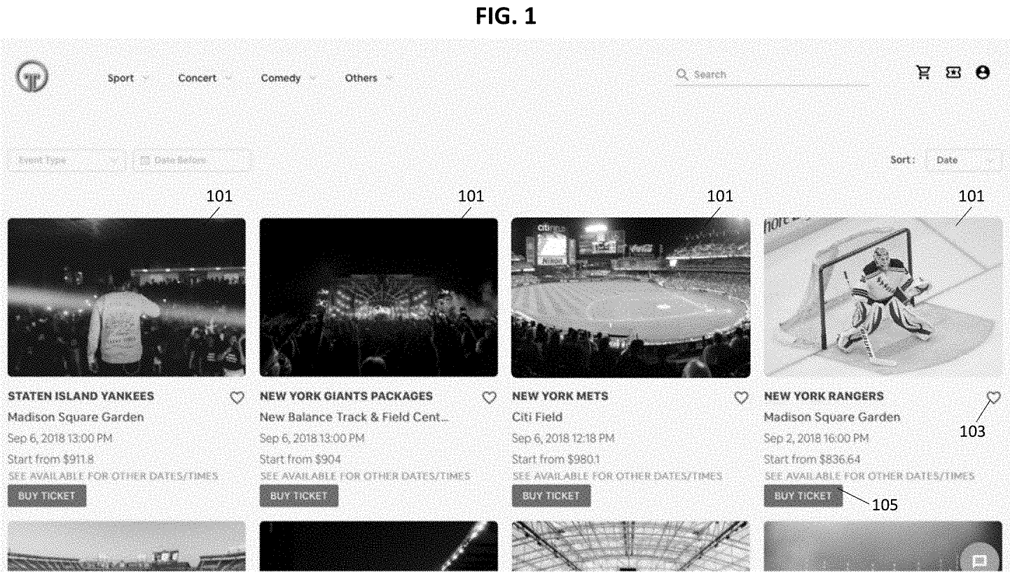

FIG. 1 illustrates one embodiment of the present invention, wherein an events page indicates events that have been matched to a user profile. The Platform utilizes artificial intelligence and machine learning, including artificial neural networks, fuzzy logic, deep learning, and/or clustering in order to provide events that are most likely to be selected or relevant to a user profile. For example, in one embodiment, a user profile includes an indication of attendance at five different NEW YORK METS games in New York City in the last year. The Platform determines that no NEW YORK METS games are being played in New York City in the next week, but several other user profiles with similar behavioral statistics, profile information, and location have bought tickets to an upcoming NEW YORK RANGERS game. Thus, the Platform suggests a NEW YORK RANGERS game as an upcoming event on the events page.

The Platform is operable to suggest a number of events 101 based on an artificial intelligence algorithm—including factoring in bookmarked, starred, favorited, or other stored events—and provide an Interest Button 103 as well as a Purchase Button 105. In another embodiment, the artificial intelligence algorithm utilizes digital cookies, single sign-ons (SSOs) through email, social media, digital media, or any other app or web-based account to the Platform, web beacons, web bugs, and/or pixels to determine browsing history and social media activity of the user and suggests the events 101 based on the browsing history and social media activity. The Interest Button 103 is operable to direct the Platform to add a user to the event and allow access to an event page, wherein other members who have been added to the event are listed. If a user wishes to skip social elements of the present invention, the Purchase Button 105 directs the Platform to provide a list of available tickets to the indicated event that are available for purchase. The Platform is further operable to filter events based on a filter criteria from a user. Filter criteria includes location, event type, average ticket price, events only connected profiles are attending, etc., and the Platform is operable to receive the filter criteria via the GUI through buttons, text boxes, drop-down menus, radio inputs, or any other selection method known in the field of GUI design.

In utilizing artificial intelligence, the Platform is operable to train a machine learning model for predicting and recommending events to user accounts based on tracked and stored user data. For example, in one embodiment, the Platform develops a model based on tracked and stored records of previously purchased tickets, previous attendance, and/or indications of interest. A machine learning algorithm identifies patterns within this data to determine and recommend future events and other targets of interest. Preferably, the processing and recommendation is performed on a server within control of the Platform. In another embodiment, the training data is supplied to an external server, wherein the external server performs functions related to the machine learning algorithm using the training data, and wherein the Platform is operable to request and receive predictions and recommendations from the external server. In a further embodiment, the machine learning model is developed on an external server, wherein the Platform is operable to transmit training data, receive the developed machine learning model, and generate predictions and recommendations based on the developed machine learning model on a device controlled by the Platform. Examples of artificial intelligence algorithms and related processes applicable to this embodiment of the present invention are described in U.S. Pat. No. 9,922,286, to inventor Hazard, which is incorporated herein by reference in its entirety.

Suggesting events to users occurs via any matching algorithm provided in the art. For example, in one embodiment, matching occurs based on a connection or relationship established between one or more user profiles. If a first user profile is connected to a second user profile, events that the first user profile is registered to attend are suggested to the second user profile. In one embodiment, personally identifying information of the first user is not presented to the second user through this suggestion. Instead, the event displays a generic indication, such as, “You have connections attending this event,” or does not display an indication at all. Alternatively, notifications highlight a common profile element between the first user and the attending user; for example, “There are two connections from your university attending this event.” In another embodiment, matches are suggested based on a geolocation of a mobile device associated with the first user account or based on a stored location of the identifying user. For example, if a mobile device is outside of a stadium while a sports event is occurring, an application on a mobile device is operable to receive a geolocation from the mobile device, determine an event nearby the geolocation, and recommend attendance and/or tickets to the user account. In one embodiment, suggestions occur via a feed or list of events.

Tickers are, in one embodiment, non-transferrable outside of the Platform. Tickets are constructed in any type of eTicketing file format commonly used in the field of digital ticketing, including portable document format (PDF) or any imaging technology, such as Portable Network Graphics (PNG), Joint Photographic Experts Group (JPEG), Tagged Image File Format (TIFF), or Graphic Interchange Format (GIF). In other embodiments, tickets are identified by a linked user account or a unique identifier (ID). The Platform in preferably in network communication with at least one external server and database of a ticket managing platform, such as FLASH SEATS, and is operable to communicate a transfer of ticket ownership (including a unique ID transfer) and/or directly manage ownership of a ticket. In one embodiment, tickets and/or unique IDs are associated with a credit card number or an account payment method. The credit card number or account payment method are either associated with a user account or are linked to a ticket purchase without being associated with an existing user account. Thus, ticket verification and tracking services at an event location that are in network communication with the Platform are operable to receive a credit card number (e.g., by swiping or dipping a credit card or providing a username associated with the credit card) and allow access to an event without a barcode or extra verification method other than a credit card or payment method. In another embodiment, the Platform is operable to convert ticket file types and automatically send purchased tickets to users in a requested file format. For example, if a ticket listing includes a PDF ticket that requires manual approval from a broker before selling, upon receiving a purchase transaction from a user account, the Platform is operable to automatically access a ticketing database, approve the ticket transfer, and convert the ticket from a PDF into a digital ticket ID managed by the Platform. The digital ticket ID is then associated with the purchasing user account. The Platform additionally stores the PDF ticket in a memory and associates PDF ticket with the user account for access in addition to the digital ticket ID. In one embodiment, the Platform is operable to receive, retrieve, and/or manage tickets on an external server, wherein the tickets are associated with a venue or distributor for direct ticket sales and management. Additionally, an administrator account associated with the venue or distributor is operable to list and manage tickets on the Platform or the external server and set prices, availabilities, sales, discounts, bundles, and available related services associated with the tickets.

Compared to prior art, this embodiment of the present invention provides a method for users to commit to going to an event and find others who are similarly committed to attending an event. Other event-based attendance systems, contrastingly, do not provide a structure that enables a commitment to an event and a connection to others who are committed to the event, since there are no technical incentives and no social obligation to actually attend or communicate with others who have indicated an event attendance. Once the Platform receives an indication of willingness to attend the event from a user account, the Platform provides tools for users to meet other people in the event. These tools improve upon both traditional social media systems, dating systems, and ticketing software by providing structured systems through which users are able to meet others with similar interests as well as conveniently communicate and divide payments for event expenses.

In a concert implementation, for example, the Platform is operable to host a virtual group, provide a list of other participant accounts, and provide matching services between user profiles attending the event. The platform is operable to receive filter criteria from a user account and identify event user accounts and event groups that match the filter criteria. In one embodiment, the Platform identifies and generates a recommendation of a set of users who meet every criterion or at least one of the criteria and sends a matched participant account an invitation to join in an event group. In another embodiment, the Platform lists a group request on a webpage, forum, or chat room for the event, and is operable to accept manual requests to join the group. When joining manually, the Platform is operable to automatically reject participants who do not meet the published criteria for joining the group and automatically approve participants who do meet some or all of the criteria.

The Platform is further operable to provide an automatic event matching and notification system, wherein a service is operable to monitor a listing of events and identify descriptions and requirements for an event that match elements of a user profile. For example, if an event is created that requires attendees to be a student of NEW YORK UNIVERSITY (NYU) who is studying business, the Platform is operable to identify the event requirements and send a notification to any user profile connected to the event creator that includes an indication of being a student at NYU studying business. A filtering mechanism is operable to monitor an allowed notification requirement attached to user accounts. For example, in one embodiment, the Platform only sends a notification when the event details match an allowed notification requirement stored in a matched user profile, such as a specific user gender, user age, user occupation, user group membership, user name or profile, event date, or event type.

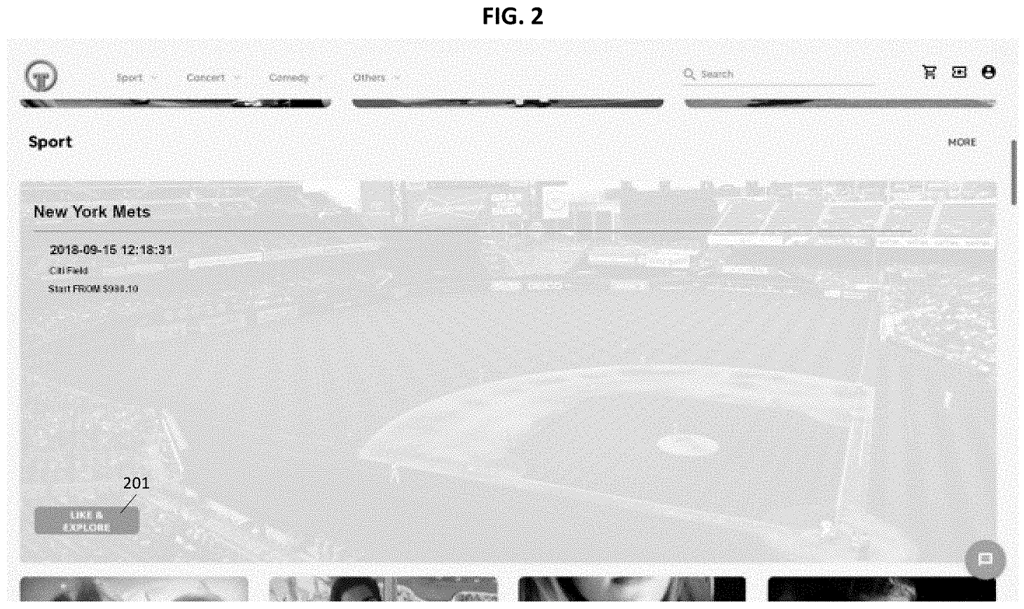

FIG. 2 illustrates one embodiment of the present invention, wherein expanded details for a New York Mets game as well as an Interest Button 201 is presented, which directs the Platform to add the viewing user account to the event page. The Interest Button 201 is a “Like & Explore” button in one embodiment.

In a further embodiment, the Platform is operable to match multiple event participants and add each user to a “Smart Chat.” The Platform is operable to match at least two users based on desired match criteria and corresponding personal user profile data. For example, if the Platform receives a request from at least one user account to attend an event with three members who attend NEW YORK UNIVERSITY, the Platform is operable to construct an attendance group within the event and allow only those who have NEW YORK UNIVERSITY listed in their profiles to join. In this embodiment, the Platform is operable to send a message, post, invitation, or other communication to other user accounts that have purchased tickets to the event or include an indication of interested in attending the event with the group membership requirements. Once a qualifying user joins the group, the user account is entered into a Smart Chat with the group initiating user and other users who have joined the group.

In an alternative embodiment, the Smart Chat provides for artificial intelligence-driven features for efficiently organizing and communicating event plans and purchases. For example, if five user accounts in a group chat wish to buy tickets to a football game, the Smart Chat is operable to detect discussion related to purchasing tickets in the Smart Chat and automatically recommend five tickets to the event that are seated near each other. Furthermore, the platform is operable to receive from each user account a preferred price range, upon which the Smart Chat is operable to base a ticket suggestion. The Smart Chat is operable to detect the discussion of an event by identifying event details from a conversation log, shared pictures, shared geolocations with timestamps, shared documents, or any other shared media or conversational item in the Smart Chat.

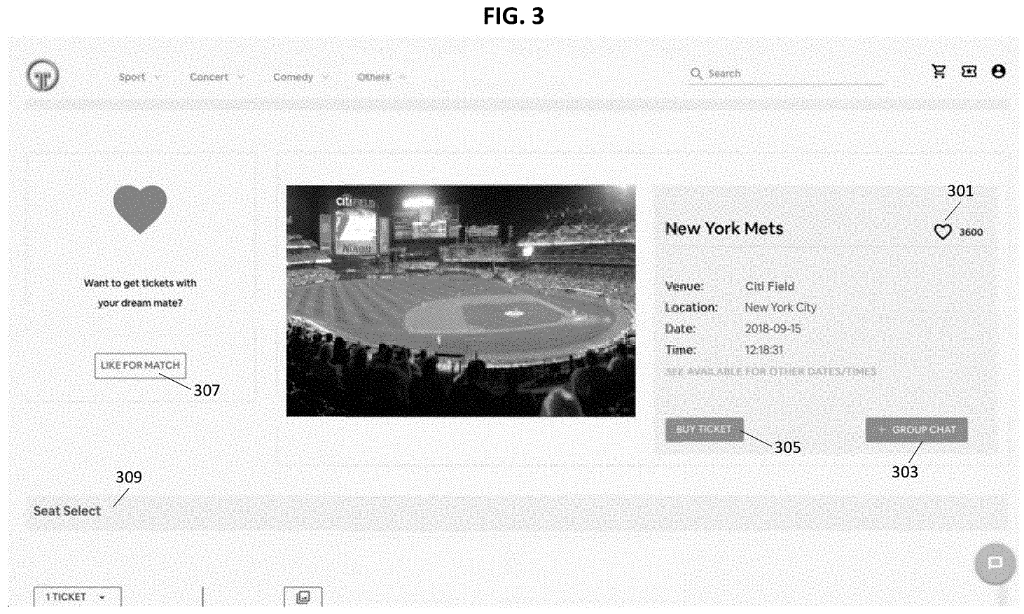

FIG. 3 illustrates one embodiment of a detail page for an event. The page provides an Interest Button 301, wherein based on an interaction with the Interest Button 301, the Platform is operable to add a corresponding user profile to the event. In one embodiment, the Interest Button 301 is a heart-shaped button. A Purchase Button 305 provides a tool for purchasing tickets to an event without social features. A Group Chat Button 303, conversely, is operable to add a user profile to create a Smart Chat, wherein the user is able to select a list of connected profiles to add to the Smart Chat. Notably, a Match Button 307 activates at least one social feature according to the present invention. Social features include a novel filtering and cost splitting mechanism, wherein the Platform is operable to receive an input, including an indication of a desire to match with one or more users, a user profile, an event and an event time, and a cost splitting preference. Cost splitting preferences include financial settings for dividing event payment. For example, the Platform is operable to provide a user with an option to split a payment evenly with another user, hereinafter referred to as an “even split.” Upon selection, the Platform then matches this user with another user who has both indicated a desire to match other profiles and has set his or her preferences to allow matches to “even split” and “other user pays.” A seat selection button 309 is operable to display the available seats and provides a tool through which users are able to provide a desired seat selection, wherein the Platform is operable to either purchase without activating the social features or enter into a Smart Chat and store a desired seat preference for splitting costs and suggesting other, similar seats or sections.

In one embodiment, the Smart Chat is a chat room, forum, webpage, feed of participant activity, or any other social networking communication implementation through which other participants can see other committed users and communicate with them. Preferably, the Platform provides a chat room, and facilitate communication of text, pictures, videos, links, or any other digital messaging item known in the prior art to other participants. The chat room is private only to the members who have indicated a participation in the event. The Platform is operable to provide a private chat room based on parameters set by a user in the group.

For example, in one embodiment, the Platform receives a request and adds a user account to a group for attending the musical HAMILTON, wherein the request indicates user profile match requirements of 25 years old, likes Italian food, and a location in Durham, N.C. This request is sent to the Platform, which automatically matches the request to a second user account of the group with a user profile that both matches each of these criteria and includes an indication of willingness to match to other people in the group. The Platform sends a notification to the second user account: “You have one new match for HAMILTON.” In one embodiment, the Platform is operable to text a number associated with the second user account or send an email to an email account associated with the second user account. In another embodiment, a message is sent via a chat or an instant message, wherein a digital messaging service or an instant messaging service is either provided through the Platform directly or is provided through an external communication service in network communication with the Platform. Upon receiving an acceptance notification from the second user account, the Platform adds the second user account into a Smart Chat with the first user. The text, email, chat, or instant message preferably includes a link for the second user to send an acceptance notification to the Platform and link the second user account to the Smart Chat with the first user.

Preferably, the Smart Chat has a time limit for a user to send a message or respond to a message before the Smart Chat is disbanded and the match removed. In one embodiment, the time limit is one day, in another embodiment the time limit is one hour, and in a further embodiment, the time limit is 10 minutes. The Smart Chat is further operable to provide the matched users with user profiles of each of the other matched users, including an event/service activity log and/or corresponding media elements posted by the matched user. For example, in one embodiment the activity log includes a listing, pictures, videos, chat history, public posts, and other history items from previously attended events. Thus, the user is able to determine whether the matched user is a human being and not a bot (e.g., a chat bot or artificial intelligence) and/or determine that the matched person is not misrepresenting himself or herself in the public or private chat room (commonly known as “catfishing” or “being catfished”). This private chat room has applications to both social meetups and networking as well as online matchmaking and dating. As opposed to prior art systems, this embodiment of the present invention advantageously provides a way for users to identify a broader personality and history of a person and interact with the person before meeting up with him or her.

Smart Chats between connected accounts and non-connected accounts differ in their implementations. A Smart Chat between connected user accounts is preferably not linked to a specific event. Instead, the Platform provides tools to add events and services to the Smart Chat and receive votes for which events or services are preferred. For non-connected accounts, Smart Chats are preferably tied to a specific event. The Platform is operable to initiate a Smart Chat between user accounts based on automatic or manual group selection or match creation. However, the Platform prevents users who are not connected with each other from forming a Smart Chat outside of the specific event or changing the event. Whereas the Platform allows connected user accounts in a Smart Chat to submit a change of event or allows voting on a specific event, Smart Chats with non-connected accounts are limited to the specific event that the Smart Chat is associated with. Alternatively, Smart Chats between non-connected accounts are enabled to accept additions of additional events or service modules that are indicated as supplemental. For example, in one embodiment, a concert listing includes an indication of supplemental services that the event is able to be paired with, including dining or facility vendor services, but the event cannot be changed to any other event. Thus, the Smart Chats are operable to be connected to advertising or vendor services by providing promotions, suggested similar events and services, and other additional event or service modules that are constructed to be implemented into a Smart Chat.

In one embodiment, Smart Chats include a minimum and maximum number of user accounts as well as an indication of allowable solo checkout features. The Platform is operable to accept and set limits based on an input from an event creator account in order to facilitate group attendance to an event and deter resale of tickets.

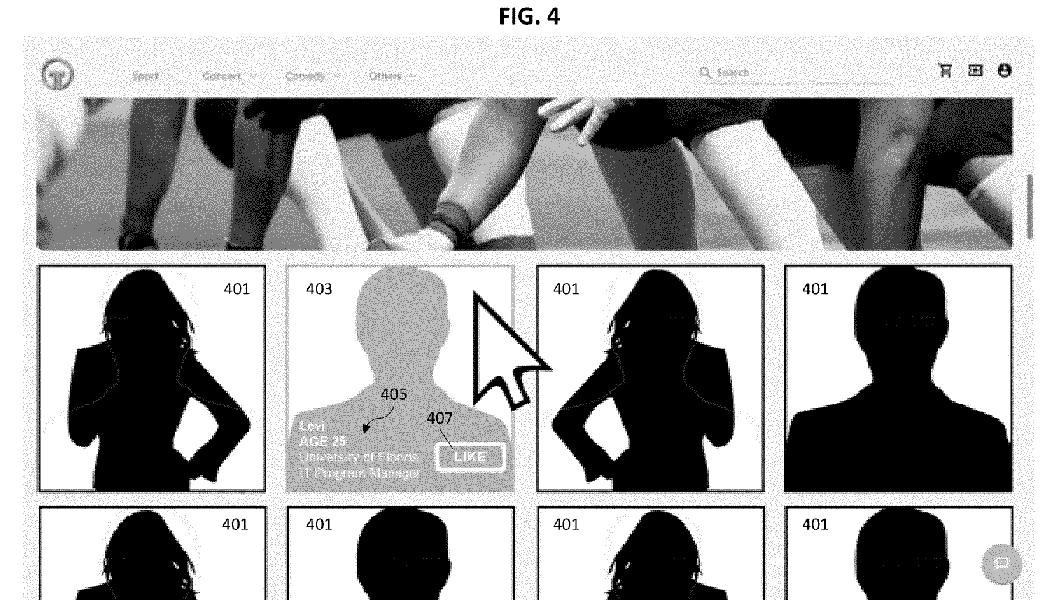

FIG. 4 illustrates one embodiment of the present invention, wherein upon a user's profile being added to the event page, the Platform is operable to display each member who has also joined the event. The Platform retrieves user profiles, including personal information and pictures, and displays non-highlighted profile pictures 401 and a highlighted profile picture 403 on the event page. Only information that the user has indicated as sharable information in his or her profile is retrieved and displayed on the event page. The GUI is operable to highlight a profile upon mouse over, wherein the highlighted profile picture 403 further displays personal information 405 and an Individual Match Button 407. In one embodiment, the Individual Match Button 407 is a “Like” button. The Individual Match Button 407 activates a match feature of the Platform, wherein an indication of a match is sent to the selected profile, and a user is operable to accept the match and join a Smart Chat with the initiating user. In another embodiment, the profile pictures that are displayed are determined based on an initial filtering mechanism. The Platform is operable to receive a desired institution, occupation, age, or gender via a search and display the event participant profiles which match the search criteria.

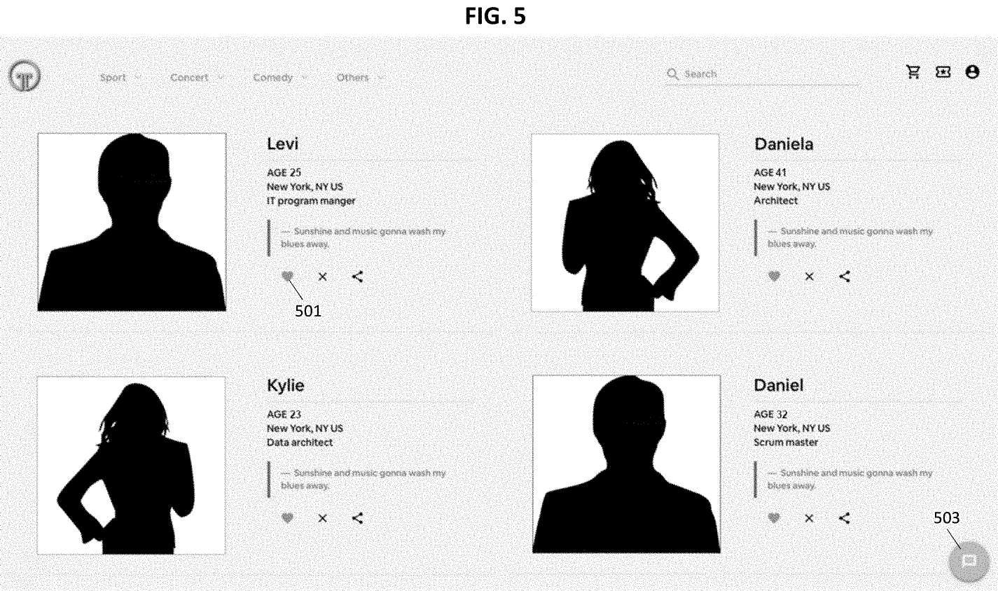

The Platform is further operable to receive a selection of connected user profiles to a Smart Chat. FIG. 5 illustrates a selection screen for user profiles that are connected to or are stored contacts of a specific user. In one embodiment, the profiles displayed correspond to registered user profiles of stored phone numbers or email addresses of a user's digital address book. An Add Button 501 adds the contact to a Smart Chat, and a Smart Chat Button 503 opens a Smart Chat with the selected users. In one embodiment, the Add Button 501 is a heart-shaped button.

A private Smart Chat preferably provides more event, communication, and connection flexibility than an event-based Smart Chat. For example, as illustrated in FIG. 5, the Platform is operable to construct a private Smart Chat based on an input from a user, wherein the input includes at least one other user profile connected to the initiating user. A private Smart Chat, in contrast to a public Smart Chat, is not tied to a specific event. Instead, the Smart Chat is in communication with at least one service database, at least one ticketing system, and at least one payment system. The Platform is operable to receive from a user a service selection, for example from an events listing page, and add the event selection to the Smart Chat. Service selections include any service that the Platform is operable to book, buy tickets for, or reserve. For example, services in one embodiment include a sporting event, a theater production, a restaurant meal, or transportation. In one embodiment, when the Platform receives a service selection, tools associated with the service selection are presented in the corresponding Smart Chat. For example, selecting a ticketing event such as a basketball game will enable price selection tools, seat selection tools, and will enable retrieval of corresponding user preferences from a user profile. An event packaging feature further allows for multiple services to be combined into a service itinerary. For example, the Platform is operable to link tickets to a basketball game, a reservation to a nearby restaurant, and a ride hailing service request to a single Smart Chat. Tools for each corresponding service are enabled in the Smart Chat, including price range selections, zone selections, menu selections, cost splitting preferences, and time selections. A Smart Chat in one embodiment automatically determines a number of tickets, number of people for a reservation, or taxi size based on a number of people in the Smart Chat. In another embodiment, the Smart Chat is operable to receive a custom number of attendees of an indication of an event guest. The Platform is operable to retrieve each preference, setting, or selection and automatically purchase corresponding tickets, book a restaurant reservation, and request a taxi. In another embodiment, for services that the Platform is not connected to or for services that do not accept digital reservations, the Platform is operable to provide contact information for purchasing or reserving one or more services. In a further embodiment, the Platform is operable to initiate a call which utilizes artificial intelligence to reserve the one or more services, and sends a notification to the Smart Chat and/or the user accounts confirming the reservation. In one embodiment, the notification includes a transcript of the call.

Notably, the Smart Chat is operable to accept a service input from any participating member. For example, in one embodiment, the Platform is operable to receive a selection of a basketball game from a first user and receive a restaurant selection from a second user. In another embodiment, the Smart Chat is operable to provide a voting mechanism for each service or event added to the group chat. The voting mechanism provides a star-based rating or a ranking system for each event added to the Smart Chat. For example, if a first restaurant and a second restaurant are added to the Smart Chat and the Platform receives a ranking from a first user of “1: First Restaurant; 2: Second Restaurant,” a ranking from a second user of “1: First Restaurant; 2: Second Restaurant,” and a ranking from a third user of “1: Second Restaurant; 2: First Restaurant,” then in one embodiment the Platform eliminates the lowest collectively ranked option, Second Restaurant.

In one embodiment, when an event or service is added to a Smart Chat, the Platform automatically recommends tickets or other booking options based on a location of the event or service, user preferences, prior group activity, and availability. The Platform is further operable to store favorite events and services. For example, if a first user has attended several football games for a specific first team and a second user has attended several football games for a second team, the Platform identifies this activity and recommends events for the first team and/or the second team to a Smart Chat of both the first user and the second user when the events are upcoming. A database and/or user profile is further operable to store events and services manually identified as a “favorite” by a user. Additionally, the Platform is operable to connect to one or more external services associated with the event and provide supplemental information within the Smart Chat. For example, if a restaurant is included in the Smart Chat, then the Platform is operable to retrieve a menu from a webpage, server and database, or other external system that stores the menu and display it through the Smart Chat.

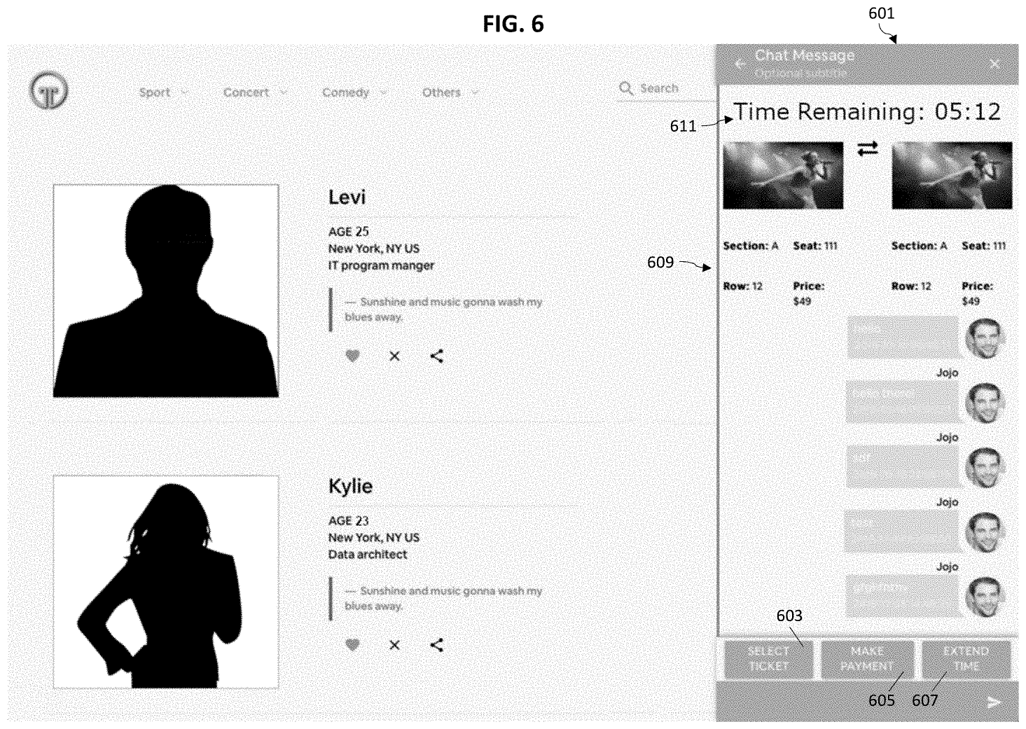

FIG. 6 illustrates one chatroom-based embodiment of the Smart Chat 601, which opens upon interaction with a Smart Chat Button. The Smart Chat 601, in one embodiment, includes buttons for coordinating payment systems of the Platform. A Select Ticket Button 603 provides a GUI for selecting tickets from a list or map, a Make Payment Button 605 activates the ticket price splitting features of the present invention and provides a GUI for a user to confirm the order and checkout. An Extend Time Button 607 allows for users to request the Platform to reset, adjust, or extend a countdown timer 611 for the Smart Chat. When the countdown timer 611 is complete, the Platform automatically disbands the chat. Event information 609 is displayed in the Smart Chat for coordination and communication between participants. Advantageously, the Platform provides an improved system for electronically coordinating event outings. Whereas in prior art systems ticketing systems and communication systems were separately controlled, leading to confusion and miscommunication between ticket purchasers, group attendees, and ticketing services, the present invention provides, in one embodiment, a Smart Chat with deadline timers, payment coordination and splitting tools, price coordination tools, and digital ticket connection mechanisms, that assure a more secure, streamlined, and coordinated system. These tools assure that all tickets that an event or broker wishes to sell are sold and delivered to digital users who are most likely to use the tickets, as opposed to scalpers, bots, or users that will return the tickets. This is an improvement over prior art electronic ticket purchasing systems. Preferably, the timer is only included in Smart Chats for non-connected user accounts. Whereas private Smart Chats between connected user accounts continue to exist after the conclusion of an event, Smart Chats between non-connected accounts that are tied to a specific service or event are controlled by the countdown timer. This assures that tickets are matched to users who are most likely to attend an event, which improves both the efficiency of the ticketing system as well as improves the user experience of matching to another potential attendee.

In one embodiment, the preferred price range is determined based on a universal slider bar that is adjustable by each member of a Smart Chat. The Platform is operable to synchronize a desired price range between members of a Smart Chat via the universal slider bar. For example, in one embodiment, the universal slider bar is presented in the Smart Chat, and the Smart Chat is operable to receive an adjustment input from any member. Any changes to the universal slider bar are displayed on each member's screen and influence the Platform's match and recommendation of tickets. The universal slider bar preferably includes two sliders, one for a lower price value and one for an upper price value.

Alternatively, the Platform is operable to provide an individual slider bar for each user in a Smart Chat. Each user's slider is visible to the other members of the group and is considered by the Smart Chat decision system. An improved GUI receives a text input from each user indicating a price range, including an upper preferred price value and lower preferred price value or receives an upper preferred price value and lower preferred price value based on a user-adjustable slider for each value. Each user's inputs are displayed on the Smart Chat interface. The Smart Chat is operable to highlight or otherwise indicate a consensus range, where the preferred price ranges of each user overlap. Whereas in the prior art users were required to individually communicate a preferred price range to other individuals who wished to buy a ticket and whereas a single organizer was required to find tickets within everyone's preferred price range, instead this improved GUI embodiment of the present invention allows for users to both see others' price ranges and communicate the price range to the Platform for automatic discovery and purchase of tickets.

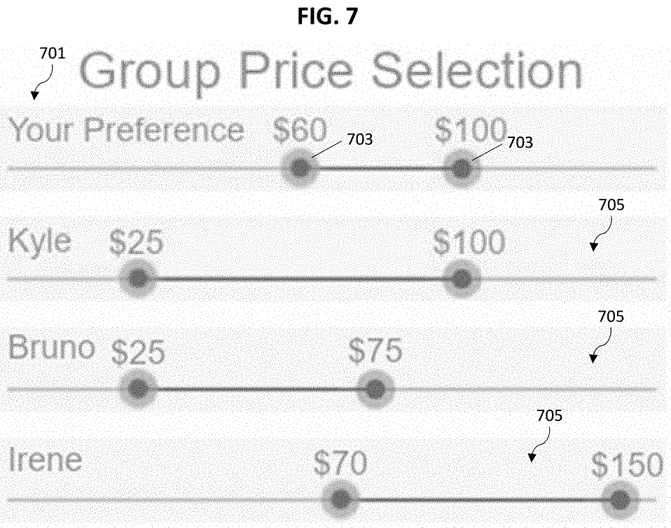

FIG. 7 illustrates one embodiment of the slider bar for a Smart Chat. In this embodiment, a logged in user is presented with an interactive slider display 701, wherein sliders 703 are operable to be moved along the slider bar to adjust a minimum and maximum price selection for a ticket selection. Slider bars from other users 705 display the settings of other members of a Smart Chat. In the illustrated embodiment, the Platform is operable to identify an overlap region of $70 to $75 that is common between each member and search for tickets corresponding to the price range. If there is no common overlap between each of the users, the system is operable to determine one or more ticketing selections that are closest in price to each of the input ranges and suggest the one or more ticketing selections to the Smart Chat. In one embodiment, the multiple user slider bars are not present, but instead the Smart Chat is operable to provide a single, universal slider bar, which is controllable by each member of the Smart Chat.

Once a preferred price range is determined, the Smart Chat is operable to automatically initiate the purchasing process. Alternatively, each user in the Smart Chat is able to click an AI button, which automatically provides tools, services, and suggestions based on a user input or analysis of a communication history in the Smart Chat. For example, once all users have communicated in the Smart Chat that their preferred price ranges are set, the group initiator or another member is able to click the AI button, wherein the Smart Chat analyzes the Smart Chat communication history, the number of users in the Smart Chat, corresponding user profiles and preferences, preferred price ranges, past user preferences and selection, and quantities of available tickets through internal or external ticketing systems in order to determine an appropriate recommendation for seating options. Preferably, the Platform is connected to one or more databases that include listings for tickets. When selecting preferred tickets, variables such as tickets sold together, high value locations, and typical ticket price are considered. Once at least one set of tickets is found that maximize each of the variables, preferences, and considerations from the users and Smart Chat, the Platform returns the recommendation to the Smart Chat, which prompts the users to accept or reject the at least one set of tickets.

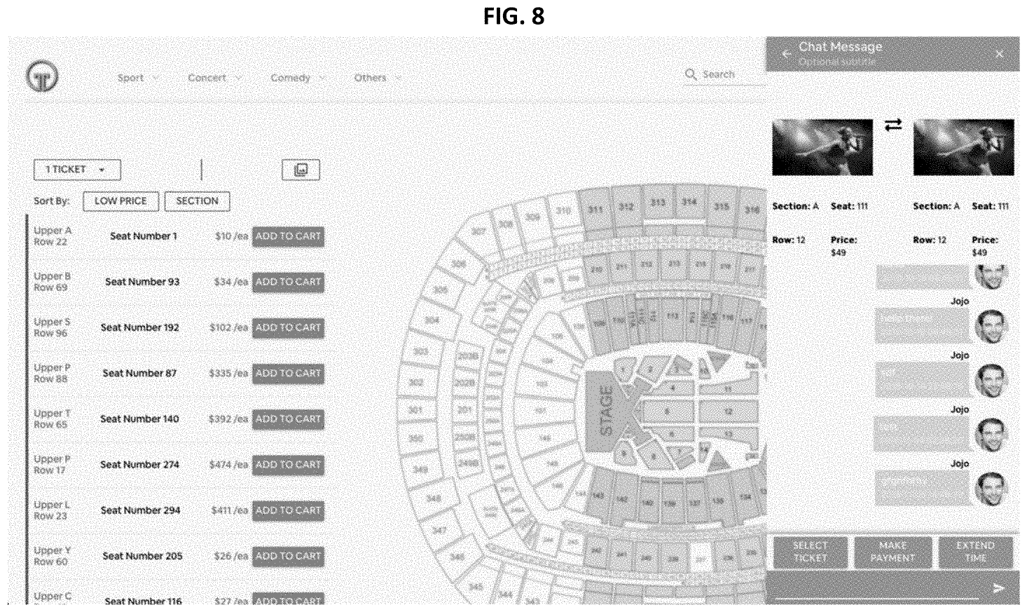

FIG. 8 illustrates a ticket selection embodiment of the present invention, wherein the Platform is operable to provide suggestions of tickets and corresponding prices based on inputs from a Smart Chat, including an AI determination of ticketing parameters from Smart Chat communication, price range inputs, and user profile ticketing preferences. The ticket suggestions are displayed either on a separate webpage or within the Smart Chat. In one embodiment, the Platform is operable to receive from each user in the Smart Chat an indication of a ticket selection preference. Each selection is preferably communicated and displayed in the Smart Chat so that each user receives an indication of the plurality of selections by the members of the Smart Chat. If a ticketing option consensus is reached and each user selection is for the same ticketing options, the Platform is operable to allow a Smart Chat initiator user to finalize the transaction and proceed to payment functionality.

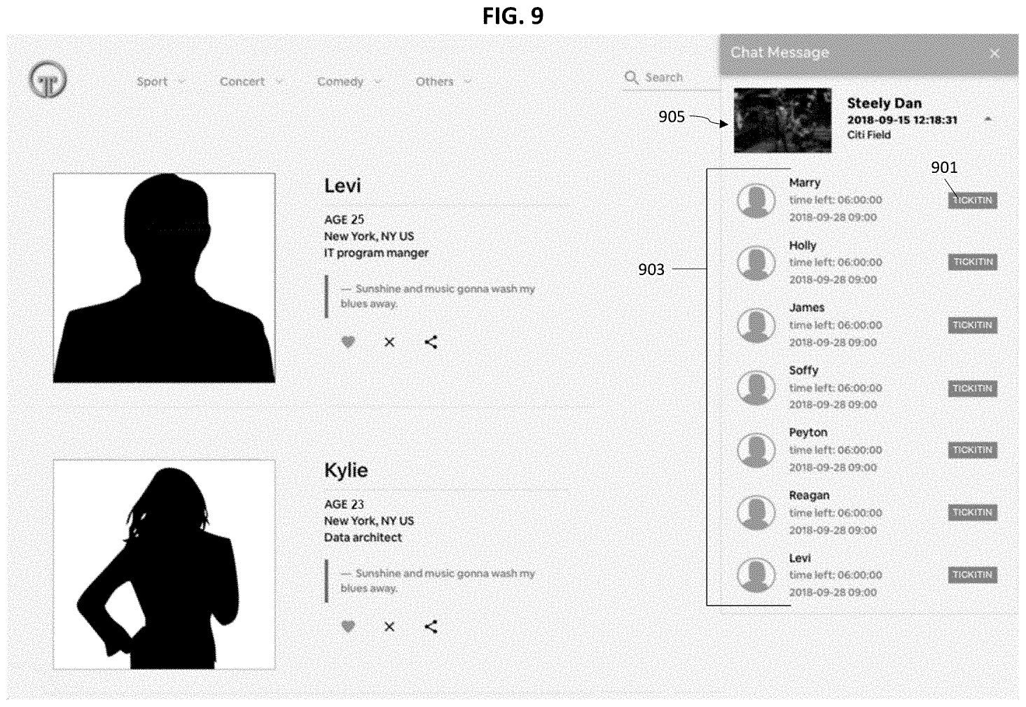

FIG. 9 illustrates a friend or participant selection feature for a Smart Chat. Upon receiving an event selection 905, the Platform is operable to provide suggestions 903 and lists of user profiles to invite to the Smart Chat. For example, the suggestions 903 in one embodiment are connected contacts of the initiating user. In another embodiment, the suggestions 903 are profiles that include an indication of a desire to attend the event with other people. An Invite Button 901 adds the corresponding user profile to the Smart Chat for organizing and purchasing tickets to the event selection 905. In one embodiment, the Invite Button 901 is a “TICKITIN” button.

Once a group of users accepts a group of tickets, the price is divided according to preferences from a group creator user account or the Smart Chat. For example, in one embodiment each user account is provided with an individual checkout system for an individual ticket of the group of tickets. Prior art systems required users to purchase individual tickets and manually coordinate with friends through other communication methods. Some tickets are not able to be sold individually in prior art systems, however, as brokers or ticketing services require a set of tickets to be sold together so as to avoid being left with a single, potentially unsellable ticket. The Platform of the present invention in one embodiment is contrastingly operable to coordinate a group purchase of tickets wherein each member is able to individually purchase his or her own desired number of tickets out of the block or set of available tickets. Thus, a recommended set of seats are presented to a Smart Chat and users are able to purchase one or more of the proposed tickets from the recommended set. Instead of one person buying the set of tickets and the other members repaying the one person a share of the cost, the Platform collects money from each person individually or bills an account associated with the user profile of each user and purchases the tickets automatically.

In another embodiment, each member confirms payment before the Platform purchases the tickets. For example, if four friends wish to buy tickets to a concert, the Platform receives payment information and confirms payment from each user account individually, but the Platform does not automatically purchase the tickets until receiving and confirming payment information from the fourth user account. The Platform is operable to reserve the tickets while the group is entering in payment information and release the tickets to the public upon a specified time limit being reached. For example, the Smart Chat is operable to offer a set of four tickets to the group of four friends, but if the fourth person does not enter payment information and confirm payment before 12 hours, the Smart Chat removes the recommendation until another ticket request is sent by the group. The Smart Chat is operable to allow an administrator account or a creator account to remove a user from the group, wherein a second search of tickets based on the new number of users is performed. Alternatively, the Platform is operable to allow users to vote to kick a member from the group chat, wherein upon receiving a majority of votes to remove the user, the user account is removed and a new ticket search is performed. Notably, the time limit for purchasing is able to be set to any value by either the Platform provider or by the ticket seller. The Platform provider in one embodiment wishes to limit the time period to purchase tickets for an in-demand event. Thus, the Platform is operable to set the time limit to 10 minutes based on a time input. A ticket broker reselling tickets in one embodiment wishes to limit an amount of time users are able to reserve his block of tickets before they purchase. The Platform is operable to set the time limit to 30 minutes based on a second time input.

In another embodiment, the Platform is operable to charge a payment account of a group leader account for reserved tickets. Each of the tickets are then attached and/or associated with the group leader account. Upon receiving reimbursement payment from at least one second Smart Chat user account, the Platform is operable to transfer the tickets from the group leader account to the at least one second user account. The Platform is operable to charge and/or reimburse a payment account for each of the group leader account and the at least one second user account, wherein the payment account is an external payment account (e.g., a credit card, debit card, or bank account) or an internal account for funds managed by the Platform and associated with a user account. In another embodiment, the Platform does not purchase or reserve tickets until an advance payment amount is received and credited to the group leader account.

Notably, payments are conducted in any currency or digital payment embodiment known in the art, including cryptocurrency, digital currency, point values, digital incentives, and digital rewards. For example, in one embodiment, purchases and reservations are made using blockchain or other distributed ledger technologies. For example, the Platform is operable to reserve tickets via a first distributed ledger, send cryptocurrency payments to an external server or broker system, charge a digital wallet for each user account, and associate or attach a reservation or ticket to each user account via the first distributed ledger or a second distributed ledger.

The Platform is further operable in one embodiment to provide to a user a method of purchasing tickets without using social features. In this instance, a user interacting with the Platform is able to request one or more tickets through an interactive seat map, ticket search, or other GUI for identifying available tickets through the system. An individual Smart Chat is further operable to be constructed for an individual use. The GUI is configured to accept from a user device an indication of desired ticket parameters, including a price level for a ticket, a preferred location, preferred users to sit near, or a preferred date. The Platform is operable to determine the price level based on the slider GUI, similar to the Smart Chat for multiple users. Additionally, an artificial intelligence-driven bot is operable to communicate with the at least one user and determine an appropriate ticketing option based on user profile preferences, information given in the Smart Chat, and ticket purchases from connected users. For example, if the Platform receives a user communication in a chat room with an AI bot that she wants to be near attendees that are fans of the visiting team and she wants to be in a seat between $45 and $80, the AI bot is operable to intelligently search the available tickets and find tickets that meet her request and/or tickets that the AI determines have a high probability of acceptance by the user. The Platform is further operable to process a single request from a user in a Smart Chat and allow the user to purchase at least one ticket. Single purchasers are not limited to one ticket, but instead the Platform is operable to fulfil orders for one or more tickets per user. An administrator for the Platform or a specific event is able to set a limit for single purchasers, such as limiting the number of tickets one person can buy to 10 tickets, 8 tickets, 5 tickets, or any other set amount.

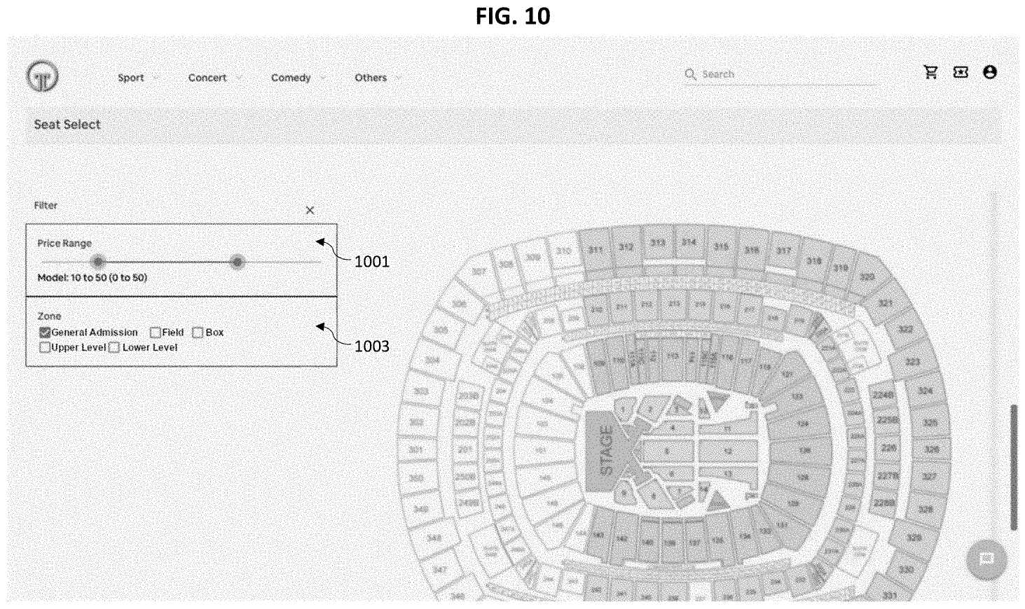

FIG. 10 illustrates an individual seat selection embodiment of the present invention, wherein a price range slider 1001 and a zone selection field 1003 are operable to receive and store an input for a desired price range and zone. These inputs, in one embodiment, are combined with AI tools to recommend seats that are relevant and most likely to be purchased by a requesting user profile. Additional inputs considered by the AI tools include user profile preferences, past seat selections and purchases, and purchased seat locations of other connected user profiles.

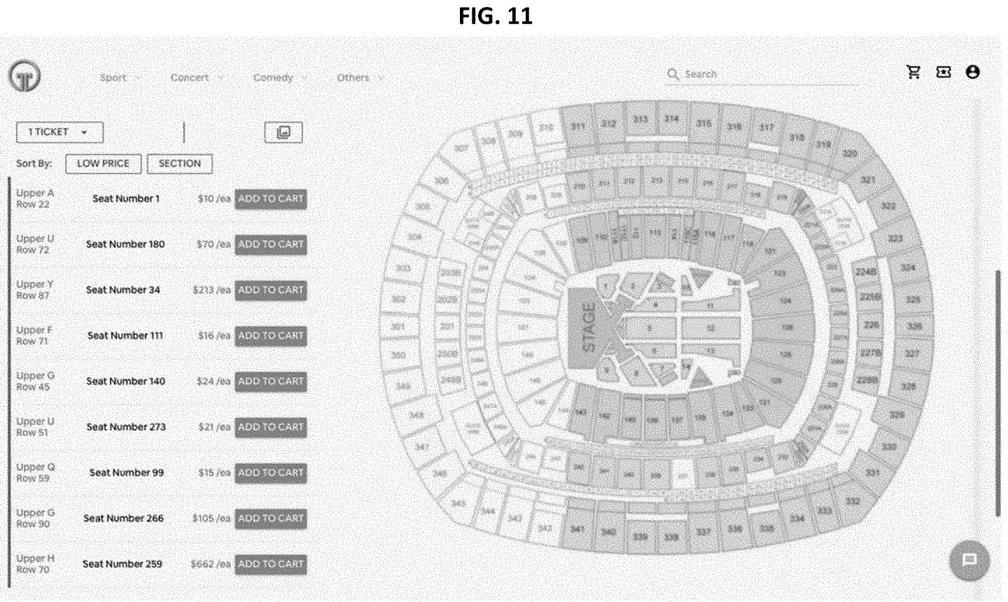

FIG. 11 illustrates a ticket recommendation and selection page similar to the suggestions within a Smart Chat. The Platform is operable to receive an input of at least one seat selection from a user and proceed to payment functionality.

Tickets are preferably listed and held in a database of the Platform. Individual brokers are able to sell tickets through the system, the Platform is operable to connect to external databases and facilitate purchasing through external ticketing systems, or the Platform is operable to connect directly to a third-party's ticket management system and facilitate ticket inventory management. In the case of a broker, the Platform is operable to receive and list a set of tickets for sale. This is enabled via a GUI, which is operable to accept ticket information, including an event, a seat location, number of tickets, etc. A ticket listing is created based on the ticket input and is instantly or near-instantly (within one to ten minutes) made available for matching to requesting users. In another embodiment, the Platform is in network communication with at least one external server and database, for example current platforms and services such as STUBHUB, TICKETMASTER, VIVIDSEATS, and SEATGEEK. Preferably, an Application Programming Interface (API) provides for communication between the Platform and the external server. The API is either Platform based or is external server based. If the API is Platform based, other external ticketing servers are operable to connect to the Platform and communicate available tickets from the external ticketing database. The Platform is operable to receive this communication and store the information in a Platform database for further ticketing operations. If the API is external to the Platform, the external system's API allows the Platform to connect to and search for tickets available in the external database during its ticketing operations. In one embodiment, the Platform is operable to restrict a number of tickets that are able to be purchased at once. Limits are set for each event individually or across all events. Thus, any accounts that are attempting to buy large blocks of tickets for resale are deterred from purchasing more than the ticket limit. In another embodiment, Smart Chats are limited to a specific number of people for a specific event so as to deter large blocks of tickets from being sold to bots or other ticket scalping entities.

The Platform is additionally operable, in another embodiment, to directly connect to ticket distributers, for example an event host or a ticket printing service. This embodiment eliminates any middle-man transfer process in the ticket purchasing system and allows the Platform to directly search, list, and suggest tickets based on a primary supplier's inventory. In a further embodiment, ticket purchasers are able to share tickets with other members. The Platform is operable to receive from a user an account that the ticket should be transferred to. For example, in one embodiment the Platform is operable to transfer the ticket based on a connected user account name or ID, whereupon the ticket is transferred from the first account to the second account. The Platform is operable to facilitate payment for the ticket before, after, or during the ticket transfer. Upon transfer, the new user account is automatically indicated as attending on the event page, and he or she is provided access to a Smart Chat, Event Chat, or Memory Wall (further described below) corresponding to the ticket's event.

Often, an event sells out such that no other users can purchase tickets to the event. Other times, there are no tickets available at a user's preferred price point. In these instances, the Platform provides a method through which users are able to request “standby” status. In standby mode, users are able to claim tickets to an event that become available last minute. For example, if a ticket broker was unable to sell a pair of tickets at a set price and eventually reduces the price, a Platform is operable to send a notification to a user account with standby status indicating tickets available within a specified price range. Alternatively, if a block of tickets is released that was previously unavailable, the Platform is operable to send a notification to all user accounts with a standby status. In one embodiment, the Platform is operable to set an automatic purchase price based on a preference from at least one user, and as soon as at least one ticket comes available meeting a set of criteria or user preferences, the at least one ticket is automatically purchased and added to the user account. For sold out events, the Platform is further operable to identify a standby user when a user with purchased tickets indicates that he or she wishes to sell or return the tickets. An automatic purchase option is also available for users who wish to buy tickets to sold-out events.

In a further embodiment, the Platform is operable to package tickets and services together and sell the package as a bundle. For example, in one embodiment, tickets to a series of related events (e.g., tickets to each home game for a basketball franchise) are identified by the Platform and automatically or manually combined into a bundle. In a season ticketing embodiment, bundles are either resold or directly sold season tickets, or bundles are a pieced together from individual tickets to form an unofficial season ticket package. Since the bundles are not limited to official season ticket packages and a single assigned seat, the Platform is operable to receive from a broker account an indication of related tickets to be sold together. Alternatively, the Platform is operable to automatically (or manually by user combination) identify tickets, events, and services that are related and offer and sell the bundle to a user. For example, the Platform is operable to package tickets to baseball games within a geographic vicinity of each other and sell the bundle as a bundle. Thus, a tourist service is able to provide tickets to both a NEW YORK METS baseball game and a NEW YORK YANKEES baseball game on a specific weekend as a bundle. Alternatively, the Platform is operable to offer a bundle including tickets to non-related events, such as a soccer game, a basketball game, and a movie. The Platform, Smart Chat, and/or other ticket selling or retrieving service is thus operable to offer, purchase, and provide the tickets as a bundle based on set rules for purchasing the set of tickets. In one embodiment, bundles are not limited to tickets in a series of events (e.g., season tickets) but instead are other related tickets and services. For example, the Platform or a broker account on the system is operable to bundle together a “Night Out” package, which provides a set of events and services for an evening outing at a discount or flat rate. A “Night Out” package, in one embodiment, includes two Uber rides of $20 each, dinner reservations at a restaurant, tickets to a symphony performance, and a $30 voucher to a wine bar. The Platform and/or Smart Chat is operable to synchronize each of these services and provide the bundle for purchase via the Platform. In another embodiment, the Platform is operable to use artificial intelligence and other computer learning algorithms to identify events and services commonly purchased together, related to each other, or in similar geographic or temporal proximity to each other, and present a suggested bundle to a broker, user, or event administrator (wherein the Platform is operable to receive from an event administrator a bundle of events or services to be paired with the administrator's event for marketing purposes).

The Platform operates to provide for bundle combinations and financing of the payments over time, such as by way of example and not limitation, in a subscription model with fixed monthly payments over a predetermined period of time after a minimum number of tickets and/or events are added within at least one custom chat on the Platform. In one example, when at least 5 events are added into a custom chat, then distributed payments via financing options or subscription are automatically available as payment options within the Platform. The custom chat may further include at least one smart chat with photo sharing about events and automatic support for additional or supplemental services, such as ride-sharing, concierge services before and/or after the scheduled event, etc.

In another embodiment, tiers of event tickets are optionally provided within the Platform, wherein the at least two tiers provide for each month, each event, and/or each venue for selections of sections for ticket seat locations within the predetermined time period (e.g., month), event, and/or venue. The selections of sections provide for “anchoring” or securement of seats within the same zone or zones. Customization by event and/or venue ensures predictability of experience for users who are not committed to entire season tickets for a single sport, team, or series of performing arts events, which solves a longstanding, unmet need of consistency and predictability of event experiences for users while ensuring flexibility to cover a wide range of event types. In one embodiment, the Platform arbitrarily sets the categories or tiers. Additionally or alternatively, if a block of tickets are available for sale for an upcoming event, to drive ticket sales the Platform automatically creates categories for groups, friends, alumni, professionals, etc. to encourage otherwise non-connected users to associate or establish a meet-up for the tier or category or block of tickets that are available through the Platform based upon user profiles within the Platform. Furthermore, an event room or media feature provides for user-based content posting for such an event and/or to visually display the group. In yet another embodiment, third parties have access to video and audio to experience events from a user's perspective who is participating as a spectator in an event on the Platform, thereby providing for hyper-targeting of content to subscribers to the Platform who are friends with or otherwise socially connected to users at the event via the Platform connections.

In another embodiment, the Platform automatically creates packages of bundled tickets for at least one event and venue over at least one predetermined period of time, i.e., the Platform generates experiences through tickets and/or services available through the Platform and presents them to users who have opted into “surprise” or “mystery” packages based upon their profiles and/or past events and venues on the Platform.

Rewards and promotions are also optionally available on the Platform based upon pre-event and post-event activities and based upon user activity levels on the Platform for a predetermined period of time.

Advantageously, the Platform offers sports teams placement within an interactive GUI wherein the teams are shown within their own managed platform or portal for offering tickets through the Platform in addition to direct sales, while maintaining the team's branding, homepage on the web, etc.

The present invention in a further embodiment provides coordination and communication tools for connecting event attendees and contacts both during and after an event. The Platform in this embodiment includes a Smart Chat that is enabled for all registered event participants (an “Event Chat”). For example, once the event begins, all participants who have confirmed tickets are entered into a private chat room, forum, webpage, feed of participant activity, or any other social networking communication implementation through which other participants are able to see other committed users and communicate with them. Event Chats are preferably created for connection between all event participants, and any other private Smart Chat for organizing events and services remains active as well. The Platform is operable to send a notification to each user account with a ticket or each user account with a device within an event location with an invitation to join the Event Chat. An administrator of the Platform or an event host is able to set the open period for the Event Chat based on the event or according to a default opening time before an event start time. The Event Chat is operable to connect users to each other and users to venue resources. For example, at a football game, the Platform is operable to enable a venue administrator account to encourage audience interaction by starting a wave. Using either the section, ticket number, or information from data sensors on mobile devices connected to the Platform, such as NEAR FIELD COMMUNICATION (NFC), geolocation systems (e.g., Global Positioning System (GPS) or Galileo), or WIFI, the Platform is operable to send a message from an administrator account to each device. In one embodiment, a message is sent to each device associated with the Platform that has purchased a ticket in Section 123 stating, “Section 123, you are starting the wave!” A countdown follows the message, “3 . . . 2 . . . 1 . . . Go!” At the same time, devices in other sections are sent a message saying “Section 123 is starting the wave . . . get ready!” A countdown follows the message, “Section 123 is starting the wave in 3 . . . 2 . . . 1 . . . Watch for the wave!”

Additionally, the Event Chat is operable to facilitate communication between participants attending the event who wish to publicly talk with others at the venue. For example, users can use the Event Chat to indicate parking availability, ask for food suggestions, or attempt to start a wave without intervention from a venue administrator account. While at an event, a private Smart Chat with event participant user accounts is further operable to connect to concessions and other venue shops in order to purchase food, merchandise, or services. For example, a user is able to send through the Smart Chat a purchase of two hot dogs and two drinks and indicate an in-seat delivery option. In one embodiment, the Smart Chat automatically detects that a mobile device associated with a user account is inside of the event location and automatically connects to a server of the event venue to determine available vendor systems. Menu, ordering, reservation features are thus automatically activated once a device associated with a Smart Chat is located within an event space. The Platform is further in network communication with the venue infrastructure and is operable to send the order to and process a payment for the appropriate vendor. The Smart Chat is operable to split the payment between at least one additional member of the Smart Chat upon request from the ordering user or the at least one additional member. In other embodiments, the smart chat uses geofencing technology, including beacons, satellite-based geolocation services, and connections to external geofencing servers in order to identify a geofence at an event venue and determine a device presence within the geofence.

An Event Chat is further operable to connect to external resources, such as live streams for text updates, video or audio streams, and social media updates from accounts related to the event. Users who are not attending the event are able to join an Event Chat separate from the Event Chat for participants and/or are able to view a feed but not communicate within the participant Event Chat.

In an additional embodiment, Event Chats are created solely for a digital event and not a physical event. For example, in a virtual reality (VR) implementation, once an Event Chat is created, each user account associated with the original Smart Chat is sent a link to a steam of a VR concert. Alternatively, the Platform is operable to accept digital event creation requests from user profiles, wherein the event creation requests include a name of the event, a link to the digital event, required user profile elements, or a required number of users. The Platform is operable to create these events and provide/recommend them to users in the same manner as physical events.

The Platform is operable to convert the Event Chat or the Smart Chat into a Memory Wall upon conclusion of an event. A Memory Wall is no longer an editable event, and further media elements cannot be added to the Memory Wall. Instead, the Memory Wall is operable to be reviewed by users and groups who attended the event as well as others who are connected to the users and groups and have sufficient privileges (as set by the users, the groups, and the event administrators). Memory Walls include a log of each message, photo, video, or audio shared in the Smart Chat and the Event Chat. In one embodiment, the Memory Wall only includes media elements shared within the Smart Chat or manually uploaded by the user account. The Memory Wall is operable to include a media share limit, which restricts a number of media elements that are able to be shared by a single user account. Additionally, in one embodiment, the list of attendees is set to public or private based on a privacy setting of an event creator account. User profiles are updated with an indication of event attendance, which is viewable to other users based on a privacy setting of each participant. Verification features for event attendance assure that the user actually attended the event. The Memory Wall in combination with the verification features provides significant benefits over prior art, as users who are looking to find people to attend an event with are able to obtain an accurate history of a user's interests as well as assure that the user is not a bot or other fake account. In one embodiment, Memory Walls are only visible via a user profile page by user accounts that are part of a shared event page or Smart Chat. In one embodiment, media captured at an event, for example a picture or a video, is automatically tagged and/or uploaded to the Memory Wall. The Platform is operable to identify media captured at the event and prompt a user to share the media to the Memory Wall upon conclusion of the event. A mobile application on a mobile device is operable to monitor a memory of the mobile device and determine when a media element has been captured, tag a media element, identify tagged media elements, and present a notification to the mobile device during an event, upon capturing of each of the media elements, or following conclusion of an attended event.

In one embodiment, the verification features include identifying a presence of at least one personal device associated with a user account and connected to the Platform. The Platform is operable to identify the at least one device at the event based on a GPS signal, WIFI connection, NFC connection, BLUETOOTH connection, or other signal means associated with the at least one device. Alternatively, a computer device at an event location is operable to receive an image, code, audio clip, or other authentication means from a ticket holder user or from at least one device associated with the ticket holder user. Upon receiving a verification of the event attendance, the Platform is operable to update the user profile with a verification indicator.

In one embodiment, Smart Chats, Event Chats, Memory Walls, and other internet chat services of the Platform expire after an event is planned or an event concludes. In an alternative embodiment, Smart Chats, Memory walls, and other internet chat services of the Platform continue to be used following an event. The internet chat services are operable to continue providing a platform to connected users or enter a dormant mode, wherein the service does not revive until a new event is attached to the chat or group. For example, in one embodiment, a private Smart Chat between a group of users enters into a dormant mode upon conclusion of a planned event, wherein no user is operable to communicate within the chat. A time later (e.g., a week), the Platform receives an indication of a desired event attendance from one of the users in the group, whereupon the desired event is then attached to the Smart Chat, the Smart Chat is reactivated, and users are able to communicate and plan the new desired event. In one embodiment, a timer is attached to the Smart Chat, wherein upon conclusion of the timer, the new desired event is disassociated from the Smart Chat and the Smart Chat reenters a dormant mode. In another embodiment, an Event Chat or Memory Wall continues to allow interaction and media sharing following conclusion of an event. In an alternative embodiment, the Event Chat and Memory Wall enters a dormant mode. The chat service or chat platform is reactivated upon an additional event being associated and attached and/or upon a related event beginning (e.g., a second performance of a traveling musical or an additional game in a playoff series).

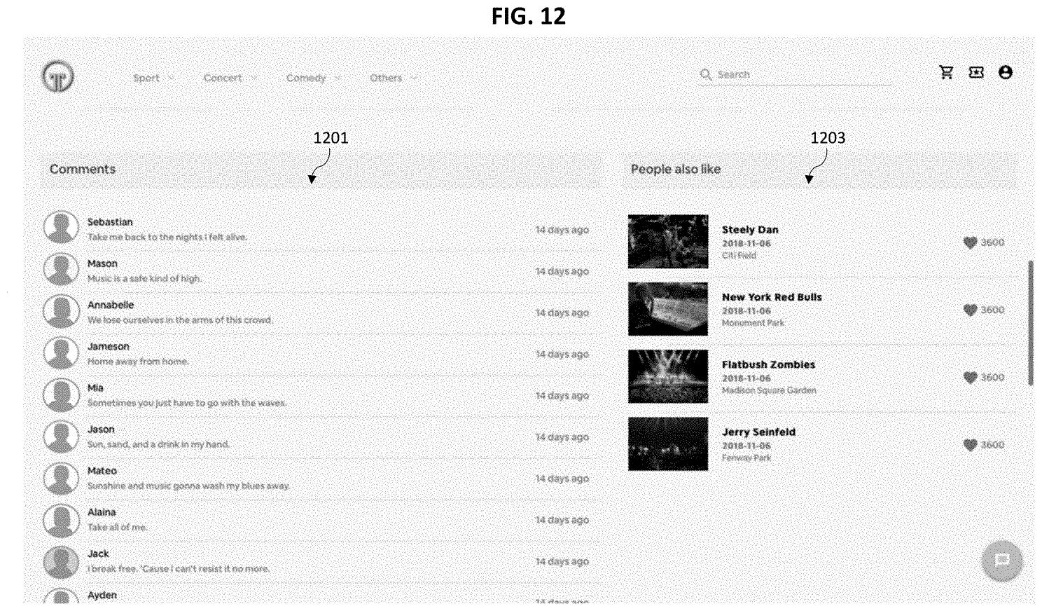

FIG. 12 illustrates one embodiment of a Memory Wall, wherein a list of comments 1201 curated from an Event Chat or other event communication source is displayed along with a list of the participants who attended the event. Additionally, recommendations to other events 1203 are provided, wherein the other events are obtained based on an analysis of personal information and preferences of a browsing user profile as well as profiles of those who attended the event associated with the Memory Wall.

Preferably, upon disbanding the Smart Chat or Event Chat, user accounts are able to rate events, services, and other user accounts. For example, in one embodiment, when an event coordinator account ends the event or a mobile device associated with a user account leaves the event location, the Platform sends a notification to the user account requesting a rating of the event, the venue, and each user in a corresponding Smart Chat. The ratings are stored in a user profile, on a Memory Wall for the event, and in memory and database of the Platform for analysis and analytics by both event coordinator accounts and the Platform.

In other embodiments, the Platform provides coordination and payment features for non-ticketing events, such as dining, travel, and lodging. The Platform is operable to connect to a third-party API, or the third party is operable to connect to the Platform API in order to coordinate and exchange purchase information between multiple users. For example, the Platform is operable to form a temporary group of three user accounts and create a reservation at an available restaurant. The restaurant system receives the reservation from the Platform and the users who are attending. In one embodiment, a Smart Chat provides a menu and an ordering system for each user before arriving at the restaurant, whereupon the ordered food set to the restaurant for preparation before the group arrives. Otherwise, the Platform is operable to receive mobile orders from user's personal mobile devices at the restaurant, or a point-of-sale (POS) system at the restaurant is able to communicate to the Platform the individual orders for each user account. Alternatively, upon receiving an input from either the participants or the restaurant, the bill is split evenly between each user or each user is able to indicate which users are responsible for line items. The Platform then charges a stored payment method for each person in the temporary group. Similar to the events embodiment, the Platform is operable to construct an Event Chat for a dining experience when the reservation time begins. Communication, including text, video, or audio shared during the time period of the event or registration is stored in the Platform and is accessible and viewable to the group members or contacts of the group members.

Access to the Platform and its servers, memory, and databases occurs via a network interface to the Internet. The services provided are deliverable to end users via a computer device, such as a desktop, laptop, smartphone, or smartwatch. End user devices are operable to communicate with the Platform and receive its services through a web browser or application on the computer device. In one embodiment, the GUI is constructed within a computer application, which communicates with the server to update information displayed within the GUI. In another embodiment, the GUI is delivered to the computer device through files or communication transmitted over the internet, which the computer device is operable to reconstruct and display.

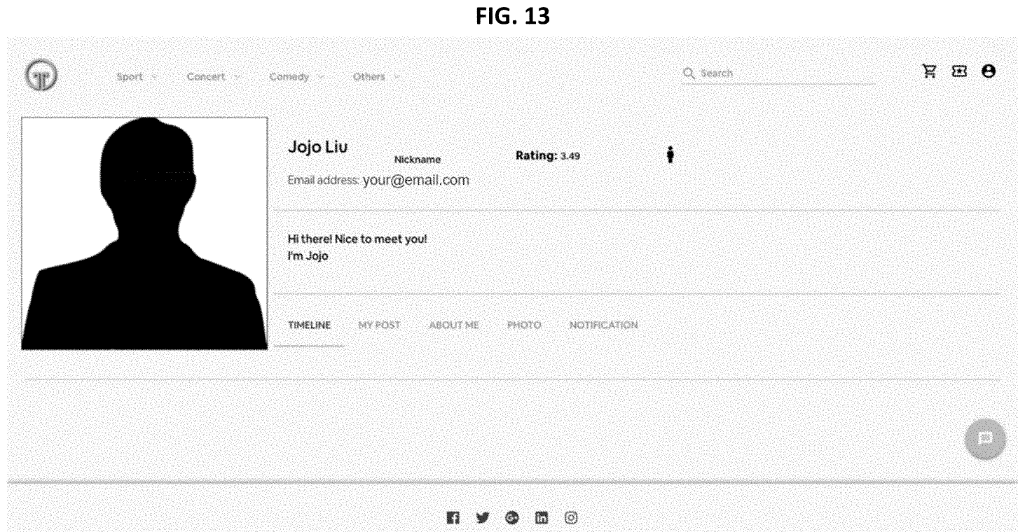

FIG. 13 illustrates one embodiment of a profile detail page according to the present invention, wherein user activity, including a Memory Wall, stored profile information, attended events and used services, a rating, a profile picture, and other identifiable information are displayed. Preferably, information is displayed based on privacy settings for a user stored in a database of the Platform.

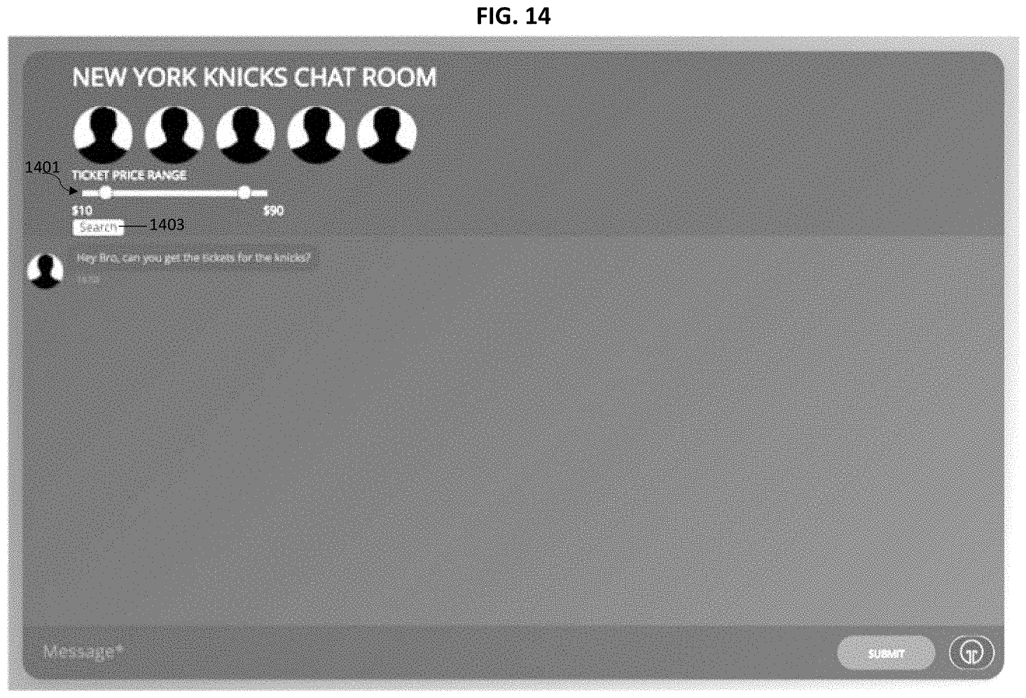

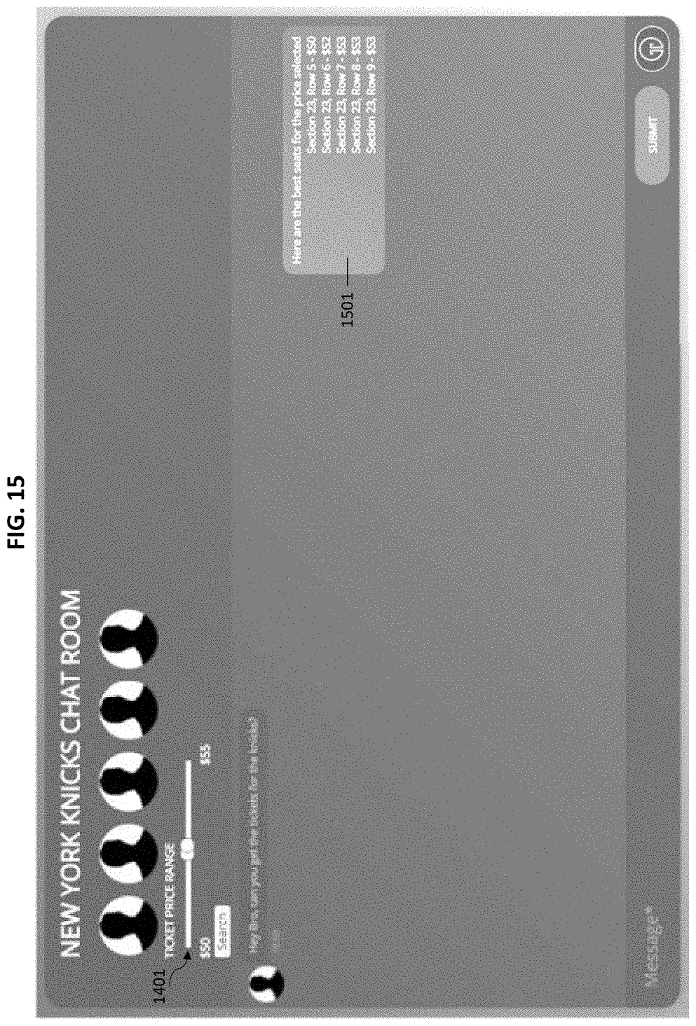

FIG. 14 illustrates one embodiment of a price range selection tool. In the illustrated embodiment, a Smart Chat includes a universal slider 1401, which is operable to receive an input and adjustment from each member of the Smart Chat. An adjustment by one user updates the universal slider 1401 for every other member viewing the Smart Chat. The slider is operable to set at least two values, including a lower price point and an upper price point. Upon receiving an interaction with the Search Button 1403, the Smart Chat is operable to query the Platform to find tickets within the specified range. FIG. 15 illustrates one embodiment of a recommendation from the Platform that is communicated within the Smart Chat. In the illustrated embodiment, the Smart Chat sends the input from the universal slider 1401 to the Platform. The depicted input includes a lower price point of $50 and an upper price point of $55. The Platform searches for tickets to event associated with the Smart Chat that meets at least this criteria. The Smart Chat then receives a recommendation from the Platform and communicates the recommended tickets to the users within the Smart Chat via a message 1501 or notification. In one embodiment, the message 1501 or notification includes buttons, links, and other interactive elements to select and view a ticket block recommendation and initiate a purchase the tickets within the Smart Chat. Notably, the number of tickets suggested corresponds to the number of members in the Smart Chat.

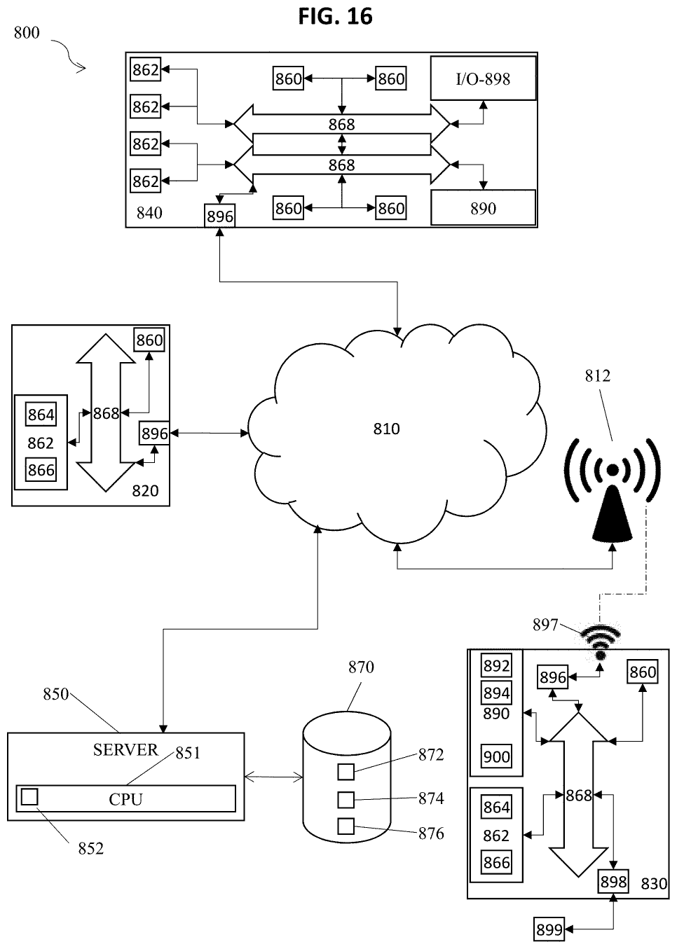

FIG. 16 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 may house an operating system 872, memory 874, and programs 876.

In one embodiment of the invention, the system 800 includes a cloud-based network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 may be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of digital computers 820, 840, 850 and mobile devices 830, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in this document

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 may additionally include components such as a storage device 890 for storing the operating system 892 and one or more application programs 894, a network interface unit 896, and/or an input/output controller 898. Each of the components may be coupled to each other through at least one bus 868. The input/output controller 898 may receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 16, multiple processors 860 and/or multiple buses 868 may be used, as appropriate, along with multiple memories 862 of multiple types (e.g., a combination of a DSP and a microprocessor, a plurality of microprocessors, one or more microprocessors in conjunction with a DSP core).

Also, multiple computing devices may be connected, with each device providing portions of the necessary operations (e.g., a server bank, a group of blade servers, or a multi-processor system). Alternatively, some steps or methods may be performed by circuitry that is specific to a given function.

According to various embodiments, the computer system 800 may operate in a networked environment using logical connections to local and/or remote computing devices 820, 830, 840, 850 through a network 810. A computing device 830 may connect to a network 810 through a network interface unit 896 connected to a bus 868. Computing devices may communicate communication media through wired networks, direct-wired connections or wirelessly, such as acoustic, RF, or infrared, through an antenna 897 in communication with the network antenna 812 and the network interface unit 896, which may include digital signal processing circuitry when necessary. The network interface unit 896 may provide for communications under various modes or protocols.

In one or more exemplary aspects, the instructions may be implemented in hardware, software, firmware, or any combinations thereof. A computer readable medium may provide volatile or non-volatile storage for one or more sets of instructions, such as operating systems, data structures, program modules, applications, or other data embodying any one or more of the methodologies or functions described herein. The computer readable medium may include the memory 862, the processor 860, and/or the storage media 890 and may be a single medium or multiple media (e.g., a centralized or distributed computer system) that store the one or more sets of instructions 900. Non-transitory computer readable media includes all computer readable media, with the sole exception being a transitory, propagating signal per se. The instructions 900 may further be transmitted or received over the network 810 via the network interface unit 896 as communication media, which may include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

It is also contemplated that the computer system 800 may not include all of the components shown in FIG. 16, may include other components that are not explicitly shown in FIG. 16, or may utilize an architecture completely different than that shown in FIG. 16. The various illustrative logical blocks, modules, elements, circuits, and algorithms described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

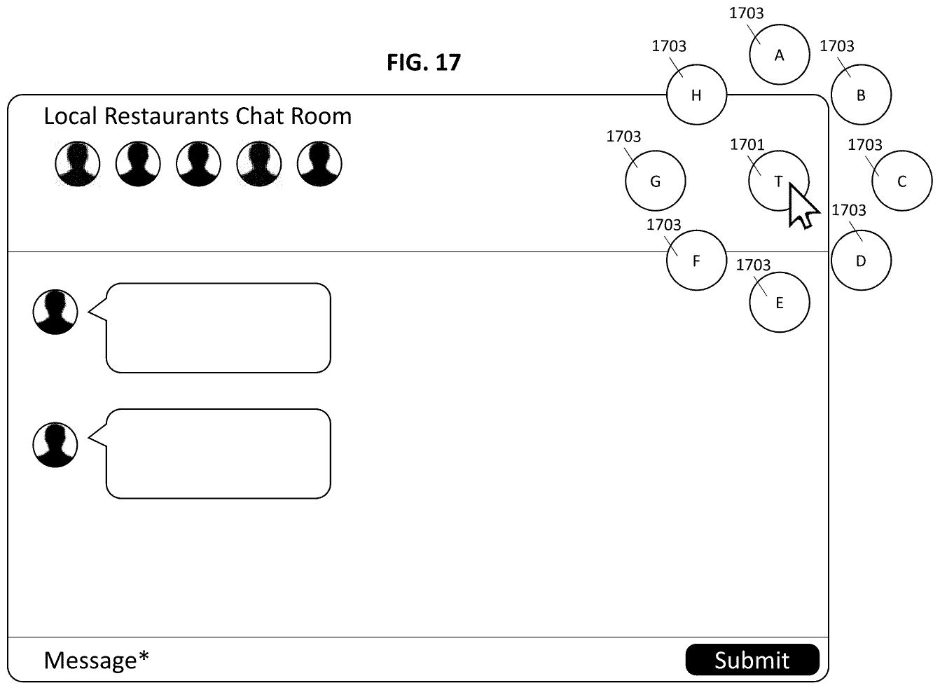

In another embodiment, Smart Chats include connections to external services, which are provided by the Platform to an individual user account or to every user account associated with the Smart Chat. For example, in one embodiment, a Smart Chat associated with a basketball game is operable to be paired to with supporting services, wherein the supporting services are associated with the event attached to the Smart Chat (e.g., a merchandise store, in-seat food delivery, or seat upgrades) or are external to the event (e.g., taxi services, restaurant reservations, parking, or hotel). FIG. 17 illustrates one embodiment of a widget that provides external services connections within a Smart Chat. A widget button 1701, upon receiving interaction via a GUI (e.g., a click, tap, drag, hover, mouse-over), displays supporting services buttons 1703, which attach additional services to a Smart Chat and/or provide services to an individual associated with the Smart Chat. In one embodiment, the Platform receives an interaction with the widget button 1701 via the GUI and subsequently displays and animates the supporting services buttons 1703. A supporting service button 1703 indicates one or more services operable to be connected to the Smart Chat. For example, in one embodiment, button 1703 A displays a popcorn icon to indicate connections to food services at an event, and button 1703 B displays a car to indicate connections to taxi services. The Platform is further operable to, upon receiving via the GUI an interaction with a supporting service button 1703 (e.g., a click), attach the associated at least one service to the Smart Chat, wherein standard user options, preferences, and inputs are processed and considered by the Platform when booking, reserving, or purchasing the services. Further, information associated with the Smart Chat, such as location, group user accounts, names, profile information, event details, preferences, and settings, is communicated to the supporting service. In another embodiment, a supporting service is operable to be presented to and controlled by a single user account, wherein the Platform is operable to coordinate individual services, such as an on-demand taxi service, for a single user account. Information from the Smart Chat is communicated to the individual service, including location, name, profile information, event details, preferences, and settings, but only the single user is operable to see and interact with the supporting service. Additionally, the Platform and Smart Chat allow a user account to share details relating to an individual service, such as a taxi estimated time of arrival (ETA) to one or more user accounts.

In another embodiment, the Platform provides a point system, wherein the Platform is operable to manage and store an amount of points for a user account, and wherein the points are gained or lost based on set rules stored in the Platform. In one embodiment, the Platform is operable to track user attendance through ticket purchases, event registrations, determined physical device locations, ticket redemptions, ticket scanning, and/or check-ins via the Platform directly or through any other external server (e.g., a ticket scanning and redemption system) in network communication with the Platform. Additionally, the Platform is operable to award points based on social rules. For example, in one embodiment, the Platform applies a multiplier to award points based on the number of users in a Smart Chat, the number of users purchasing tickets as a block, activity frequency within the Platform, and/or the number of referred and/or invited users. In another embodiment, the Platform is operable to subtract points or apply penalties to the user account, wherein penalties incentivize user engagement through the Platform. For example, in one embodiment, rules of the system are constructed such that a negative action results in a subtraction of user points or in a penalty being applied to the user accounts. Negative actions, in one embodiment, include a cancellation request from a user account, determined absence of a device associated with a user account, ticket returns, ticket resales, reports from additional user accounts, lack of ticket redemption at an event, and/or lack of check-ins at an event.

Preferably, the Platform is operable to track and manage points for a user account as well as provide a server for redeeming and applying rewards and incentives based on the points. For example, in one embodiment, the Platform automatically grants backstage event tickets to user accounts that have points above a set level and are associated with purchased tickets to a concert. In another embodiment, the Platform is operable to receive a request for purchasing a reward or incentive from a user account, wherein upon granting the reward or incentive, a pre-defined amount of points is subtracted from the user account. Rewards and incentives include at least one of: cash back, discounts, account access, account passes, and free tickets. Alternatively, rewards and incentives are purely digital, including modification of a profile design, access to an exclusive Smart Chat, Event Chat, or Memory Wall, or any other digital incentive known in the art. In one embodiment, reward points and reputation points are calculated individually, and the Platform is operable to add both reward points and reputation points based on a single action (e.g., attending a concert). In another embodiment, reward points are only accessible and displayed to corresponding user accounts, whereas reputation points are displayed publicly to other user accounts. In one embodiment, reputation points are modified by the Platform based on user reports from user accounts. In one embodiment, the reputation points are modified by a first user account adding or subtracting reputation points associated with a second user account.

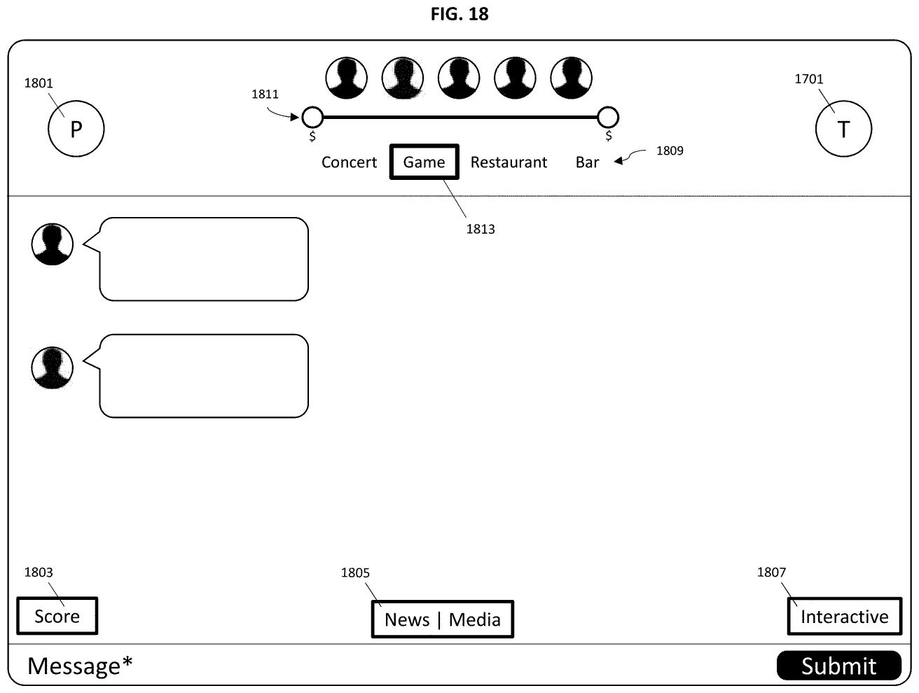

FIG. 18 illustrates one embodiment of a Smart Chat attached to multiple services, wherein the Platform is operable to receive preferences for each individual service. The Platform is further operable to reserve, purchase, or coordinate the individual services and combine the individual services into an itinerary. The illustrated Smart Chat provides via a GUI including event buttons 1809 for each attached service or event, wherein upon receiving a selection for one the event buttons 1809, the Smart Chat displays preference tools which modify preferences, settings, and search or purchase criteria for each attached event. For example, in one embodiment, a slider 1811 is displayed that corresponds to individual price preferences for the selected event. In the illustrated embodiment, the Game button 1813 is selected, corresponding to an attached sporting event, wherein the Smart Chat presents and enables an individual price slider 1811 for the sporting event, which controls a desired upper limit and a desired lower limit for tickets to the event. A points widget 1801 activates point application features, including applying points to a specific purchase, selecting a third-party points service, and/or attaching points, awards, or incentives managed by the Platform. The Smart Chat further provides connections to external information services, including scores, news, media, entertainment, directions, hours, contact information, online chat systems, promotions, advertisements, games, or community engagement platforms. In the illustrated embodiment, the Smart Chat provides connections to scores 1803, news and media 1805, and interactive content 1807. Upon receiving a selection of any of these connection elements, the Platform and/or Smart Chat access an external or internal server to retrieve the requested information. The information is then displayed in any manner known in the art, including as a pop-up, a chat message, an audio or video alert, an overlay, a text message, or a phone call.

In another embodiment, the slider 1811 controls a combined price for each of the events attached or associated with the Smart Chat, wherein upon adding or modifying events, the Platform is operable to alert a user account or announce a public message within the Smart Chat communicating that a set budget overall has been met or exceeded. The Platform is further operable to automatically suggest preferences for each of the assigned or associated events based on a set overall budget. For example, if both a restaurant and a concert are associated with a Smart Chat, and an overall budget is set to $100, the Platform is operable to recommend tickets that cost $70 and items on a restaurant menu that total $30 or less. In one embodiment, every user account associated with the Smart Chat is operable to set an individual total budget, which is visible to every other member of the Smart Chat, and wherein suggestions, preferences, and settings of the Smart Chat are governed by each of the individual total budgets.

In one embodiment, the Smart Chat includes a betting service, wherein the Smart Chat is operable to receive, coordinate, and process gambling interactions for an attached or associated event. For example, in one embodiment, a basketball game is attached to the Smart Chat. The Platform is operable to retrieve betting lines from an external system and/or determine betting lines for the Platform, Smart Chat, or subset of user accounts. The Platform is operable to receive through the Smart Chat at least one bet from at least one user in the Smart Chat for one or more event outcomes, scores, results, counts, or statistics, and charge at least one payment method for the at least one account. In one embodiment, gambling funds are stored within the Platform itself and associated with the at least one account, wherein the gambling funds are accessible during betting operations within a Smart Chat. The Smart Chat is further operable to present trivia questions, available gambling opportunities, or other interactive elements via the GUI to user accounts associated with the Smart Chat. Upon receiving input via the interactive elements, the Platform is operable to adjust a point total, reputation score, gambling funds, account balance, or charge amount for at least one user account. The Platform is further operable to access external gambling systems or external statistics reporting systems to coordinate and verify results for placed bets. In one embodiment, a series of interactive elements (e.g., trivia questions) are presented in the Smart Chat, wherein each element is associated with a specific point value or monetary value, and wherein upon receiving a specific response from at least one user account, the Platform is operable to adjust a point total or monetary value of the at least one user account. Alternatively, the point total or monetary value is governed by a division of total funds by a number of specific responses from other user accounts.

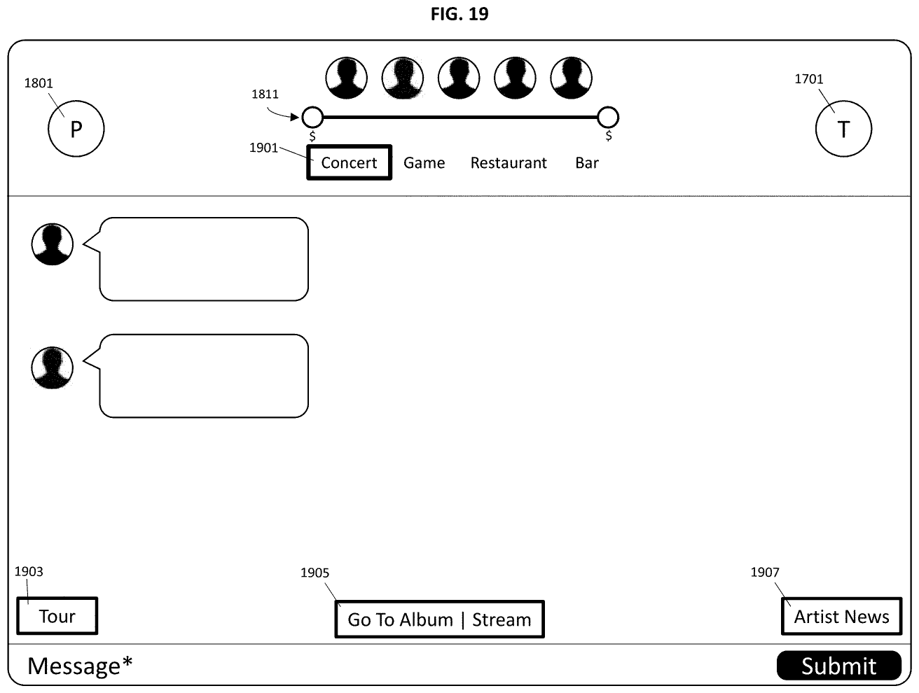

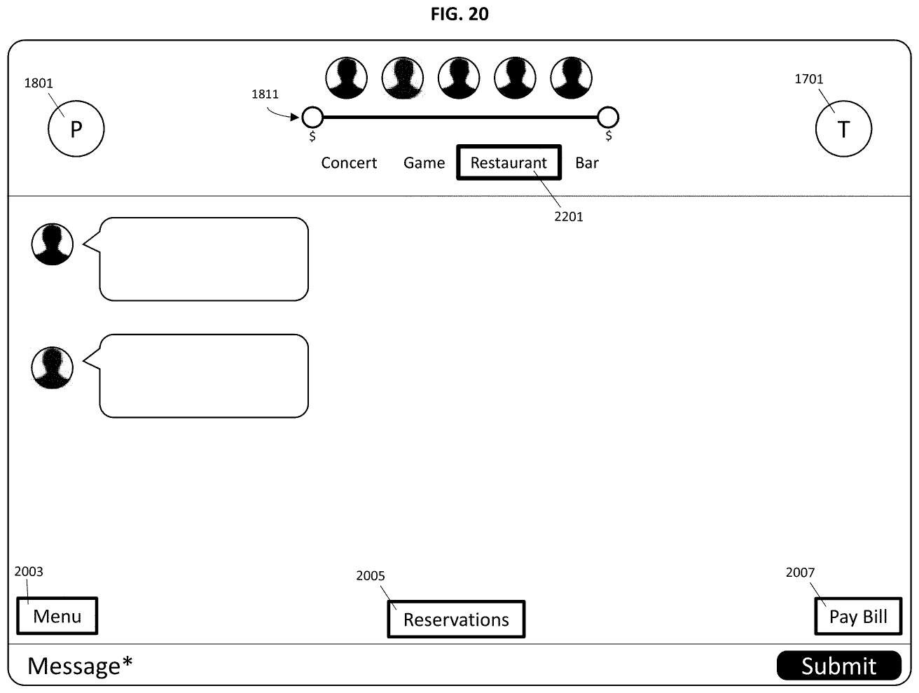

FIG. 19 illustrates a second embodiment of the Smart Chat attached to multiple services, wherein upon receiving a selection of a second event attached to the Smart Chat, the external information services are updated to match the selected event. In the illustrated embodiment, the Concert event button 1901 is selected, and the external information services are updated to match the event, including connections to tour information 1903, related digital media 1905, and artist news 1907. FIG. 20 illustrates a similar embodiment, wherein a restaurant button 2201 is selected, and the external information services are updated to provide a menu 2003, reservations 2005, and an option to pay or split a bill 2007.

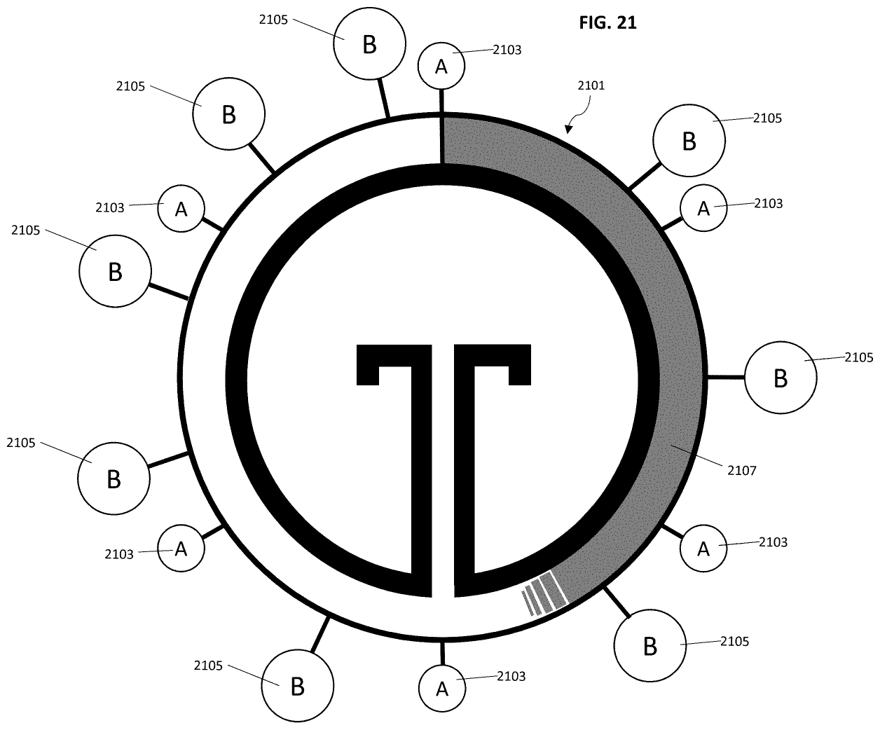

FIG. 21 illustrates one embodiment of a rewards progress indicator, wherein the rewards progress indicator 2101 is presented via a GUI of the Platform. The Platform is operable to adjust the rewards progress indicator 2101 relative to a number of points associated with a specific account. Rewards and achievements are presented along an outside of the indicator, wherein the Platform is operable to group rewards and achievements based on type, cost, previous interaction, or other pre-set criteria. For example, in one embodiment, when a point total is reached for unlocking or enabling Type A rewards, the rewards progress indicator 2101 presents or animates a progress level 2107 to align or match the Type A reward object 2103, wherein the progress level 2107 is a shading, progress bar, symbol, text, or equivalent digital progress indicator. Similarly, Type B reward objects 2105 indicate a point level has been met for Type B rewards. The reward objects (2103 and 2105) are not limited to the illustrated embodiment, but instead reward objects are operable to be presented as bars, symbols, text, or equivalent digital progress indications. Once a points level associated with a user account attains a level associated with a specific reward or incentive, the Platform automatically updates the rewards progress indicator 2101 to reflect the level.

Preferably, internal rewards or rewards offered by third party systems are coordinated, tracked, and managed by the Platform. For example, in one embodiment, the Platform automatically assigns incentives or rewards to an account based upon an attained points level. In another embodiment, the Platform assigns incentives or rewards to an account, wherein the incentives or rewards correspond to incentives or rewards of an event. For example, upon purchasing tickets or associating a user account with an event, the Platform is further operable to assign incentives and rewards to the account. Upon reaching a set amount of overall points or event-specific points, the Platform is operable to apply the incentive or the reward to the user account. In another embodiment, the Platform is in network communication with one or more external loyalty, reward, or incentive server (e.g., a credit card points system, a frequent flyers system, or a hotel rewards platform) and is operable to retrieve a point balances, rewards, and/or incentives from the external loyalty, reward, or incentive server. Upon interacting with events and other aspects of the Platform, the Platform is operable to adjust an external or internal point amount and/or apply external or internal rewards or incentives.

In one embodiment, 10 points allow a food and beverage discount, 1,000 points allow access to a private event, 25,000 points allow free tickets, 50,000 points provide celebrity access, and 100,000 points provide tickets or reservations in a specific area (e.g., court side seats).

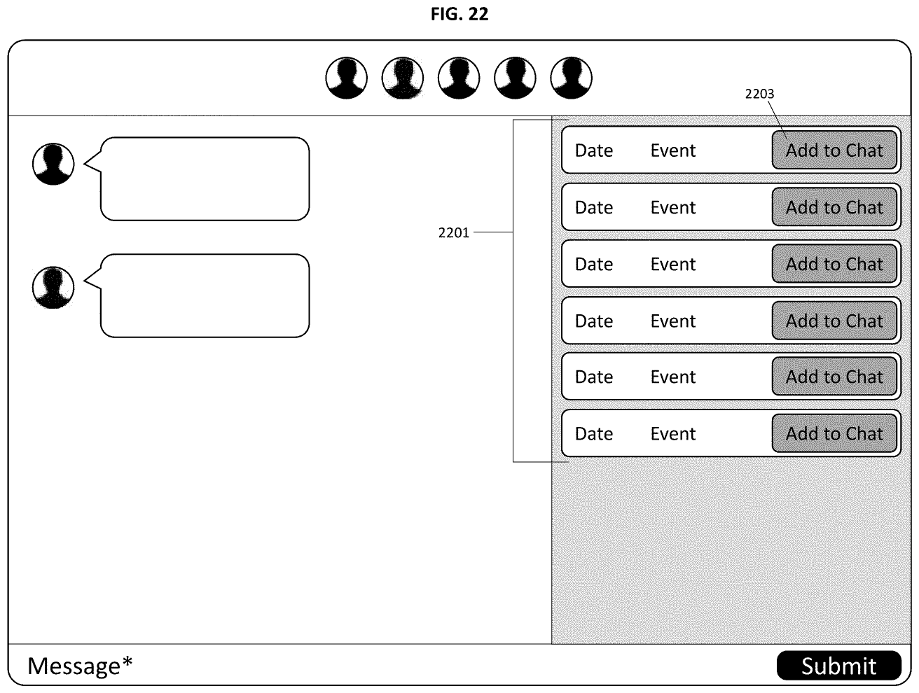

In prior art systems, tickets to events are usually purchased via an interface that allows selecting a seat, a zone, or a price level, whereupon the event or the tickets are added to a digital shopping cart for individual checkout. These systems usually do not provide other methods of coordination between members of an attending party. In contrast, the claimed invention provides an improved system and method for purchasing tickets, wherein, in one embodiment, events are not added to a shopping cart but are instead attached or associated with a Smart Chat. FIG. 22 illustrates one embodiment of a Smart Chat with an event attachment and purchasing system. In one embodiment, the Platform provides via the Smart Chat an event list 2201, wherein the event list includes events that the Platform is operable to attach to the Smart Chat and manage ticket purchases or reservations. “Add to Chat” buttons 2203 are provided via the GUI, wherein the Smart Chat is operable to receive an indication of interaction with the “Add to Chat” buttons 2203, and wherein the Platform is operable to attach the associated events to the Smart Chat and enable accompanying social and purchasing features. In one embodiment, the Smart Chat is an individual Smart Chat, wherein events are added, managed, coordinated, and purchased as a group with a group Smart Chat, but no other user accounts are associated with the social features or events. Thus, the Platform is operable to provide a system that provides itinerary features, event-specific community features, and incentives or rewards to a single user account without the need to add other user accounts. Notably, “event” refers to any attachable digital good or service, including a ticketed event, a restaurant reservation or order, a transportation reservation, or any other related good or service managed by the Platform.

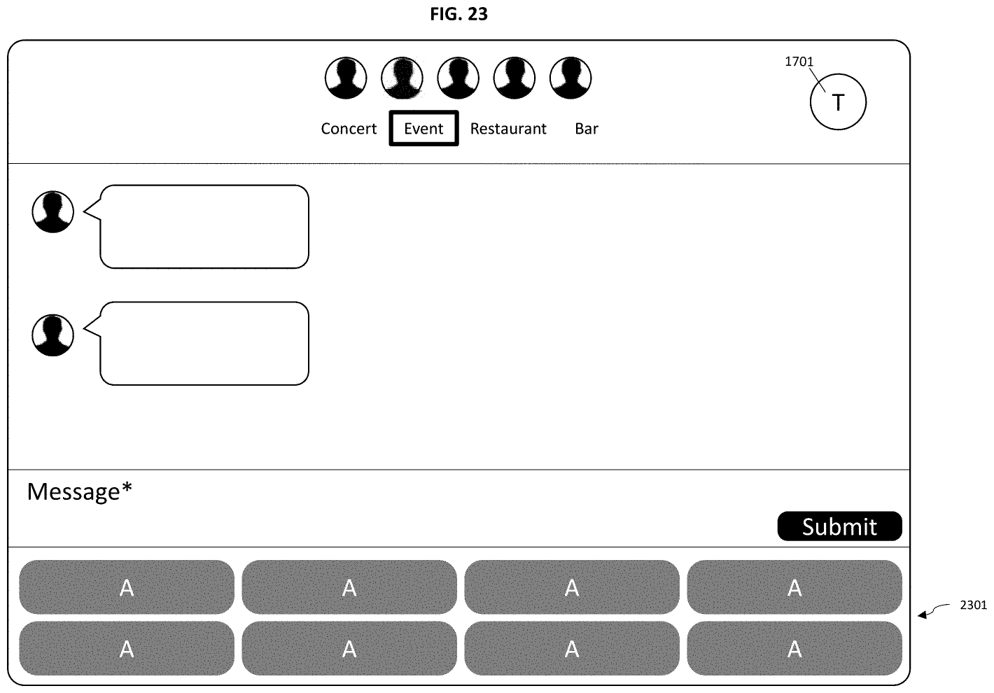

FIG. 23 illustrates another embodiment of a Smart Chat, wherein an attached event provides supplemental coordination services. In one embodiment, a series of buttons 2301 are presented, wherein interaction with the buttons 2301 establishes connections to related informational services (e.g., news, scores, related events), additional communication services (e.g., event coordinator messaging, ticket broker messaging), and additional ticketing features (e.g., waitlist request, bill split). In another embodiment, the Platform is operable to, upon receiving an indication from a user, add an event to a user account wish list and/or add the user account to a pre-sale or waitlist. Preferably, a pre-sale or waitlist request includes preferences for purchase or reservation, including a desired price, location, venue, date, time, or group members.

The Platform is further operable to determine a location of one or more user devices associated with at least one user accounts in the Smart Chat and adjust services available within the Smart Chat based on a location of the one or more user devices. Upon detecting a change in location of the one or more user devices, the Smart Chat is operable to enable a travel mode, which provides connections to local services. For example, in one embodiment, the Platform is operable to determine that a user account in a Smart Chat has a location in an airport and adjust the Smart Chat external services to include those that provide connections to flight information, taxi services, airport food vendors, etc. In another embodiment, the Platform is operable to recommend events available in the new location to user accounts. For example, if a user account with a home location of New York City has an updated geographic location of Rome, Italy, the Smart Chat presents to the user a suggestion of upcoming concerts, restaurants, and lodging within a set geographic radius. In one embodiment, a maximum distance for event recommendations are set by individual user accounts. In another embodiment, the event recommendations are governed by geographic or political boundaries. Upon detecting a change in location of greater than the set distance, the Smart Chat is operable to enable the travel mode.

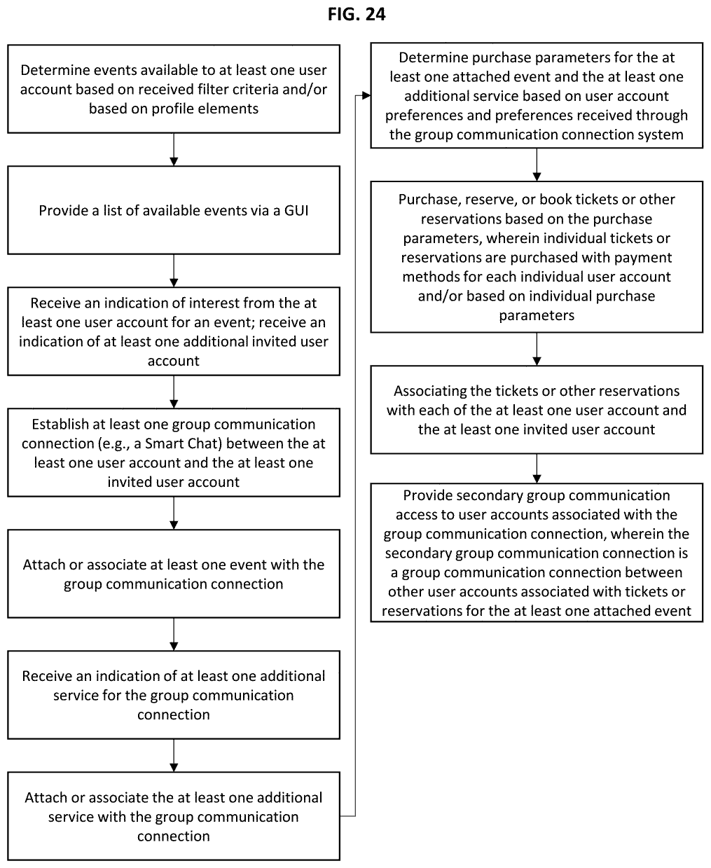

FIG. 24 illustrates a flow chart for establishing a Smart Chat or other group communication connection between user accounts for purchasing tickets or making reservations. In one embodiment, the Platform is operable to: determine events available to at least one user account based on received filter criteria and/or based on profile elements; provide a list of available events via a GUI; receive an indication of interest from the at least one user account for an event; receive an indication of at least one additional invited user account; establish at least one group communication connection (e.g., a Smart Chat) between the at least one user account and the at least one invited user account; attach or associate at least one event with the group communication connection; receive an indication of at least one additional service for the group communication connection; attach or associate the at least one additional service with the group communication connection; determine purchase parameters for the at least one attached event and the at least one additional service based on user account preferences and preferences received through the group communication connection system; purchase, reserve, or book tickets or other reservations based on the purchase parameters, wherein individual tickets or reservations are purchased with payment methods for each individual user account and/or based on individual purchase parameters; associate the tickets or other reservations with each of the at least one user account and the at least one invited user account; and provide secondary group communication access to user accounts associated with the group communication connection, wherein the secondary group communication connection is a group communication connection between other user accounts associated with tickets or reservations for the at least one attached event.

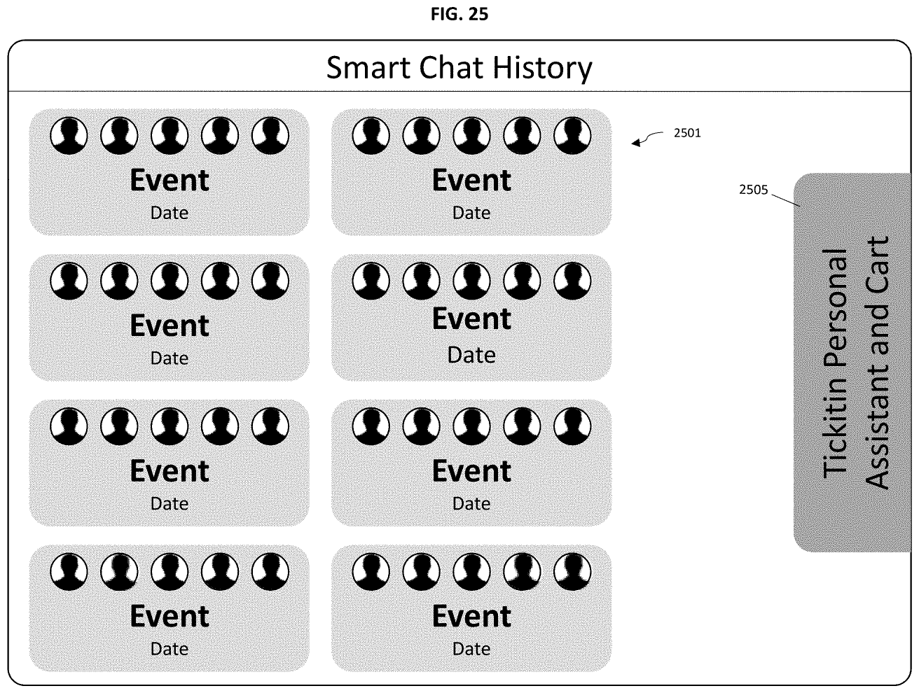

FIG. 25 illustrates a Smart Chat history. In one embodiment, each Smart Chat created by a user account is stored within the Platform and provided in a Smart Chat History. For example, in the illustrated embodiment, a list of previous events 2501 are provided, wherein each event in the list includes at least a Smart Chat name or a name of associated events, a date, and a list of user accounts associated with the Smart Chat. In another embodiment, a personal Smart Chat 2505 is provided in the Smart Chat History, wherein the personal Smart Chat 2505 is a single-user service for purchasing tickets and organizing events for a single user account without other social features or additional user accounts. Preferably, individual Smart Chats 2505 or other private checkout means are non-removable from a user account, whereas other events are operable to be removed from a user account. Both private checkout means and public Smart chats are operable to be displayed publicly and/or set to private display only. In another embodiment, the Smart Chats in the Smart Chat history are Memory Walls or Event Chats.

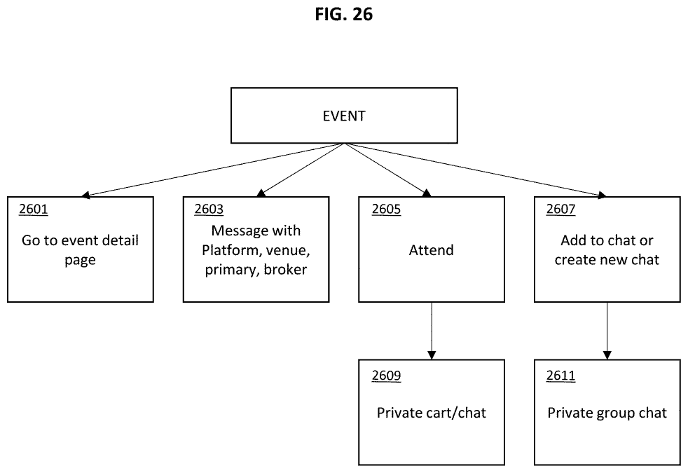

FIG. 26 illustrates functions provided by the Platform for each event within the system. In one embodiment, an event provides access to a detail page 2601 for the event, including access to descriptions, pictures, videos, attending users, and retrieved social media content. Additionally, the event provides connections to messaging services 2603, for example a chat service for communication with event administrators, an event venue, primary contacts, and ticket brokers. Upon receiving an attendance request 2605, the Platform is operable to attach or associate the event with a private digital shopping cart or a private Smart Chat 2609. Alternatively, once the event is added to a private Smart Chat, the Platform is operable to add additional user accounts to the private Smart Chat. Lastly, the Platform is operable to, upon receiving an indication or request from a user account, add the event to a Smart Chat or create a new Smart Chat 2607. Once an event is attached or associated with the Smart Chat, the Platform is operable to invite or add additional users to the Smart Chat 2611.

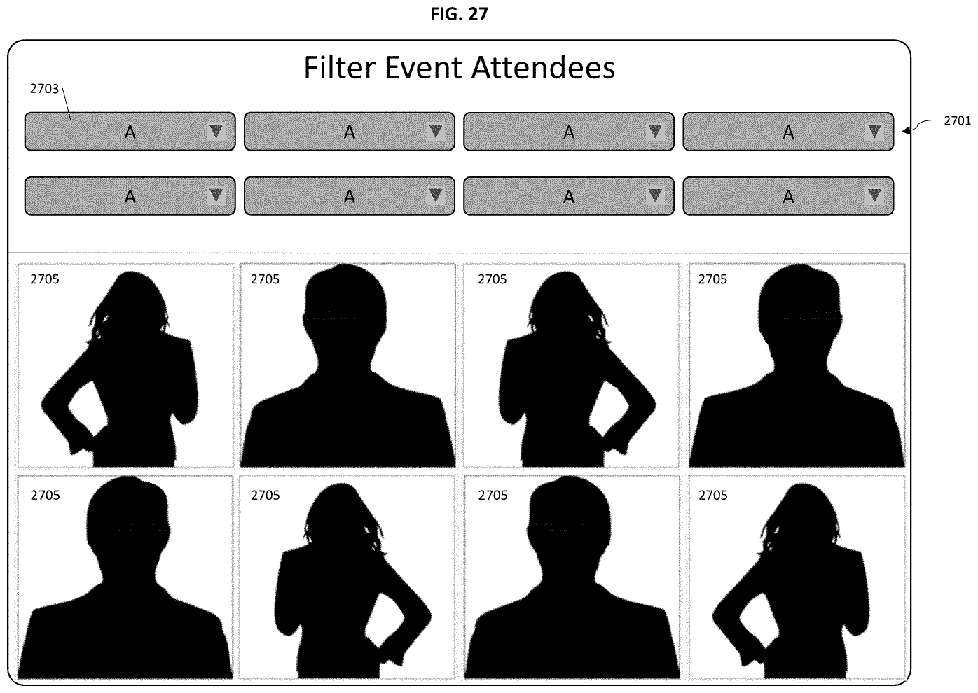

FIG. 27 illustrates one embodiment of a filter page for a list of user accounts. The filter page is, in one embodiment, accessible to a user account upon the Platform receiving an indication of attendance at an event. In another embodiment, the filter page is accessible outside of a specific event or Smart Chat and presents a list of user accounts associated or connected to a first user account. In a further embodiment, the filter page is accessible within or in connection with a Smart Chat, wherein the Smart Chat is operable to allow user accounts to be added based on specified filter criteria. In the illustrated embodiment, filter criteria 2701 are specified via filter selectors 2703, wherein the filter selectors are any digital selector known in the art, including a tick box, a drop-down menu, a text box, a search bar, a highlighting mechanism, buttons, etc. The Platform receives each of the filter criteria 2701 and filters the list of user accounts displayed 2705 to present only those with matching profile elements. In another embodiment, the Platform receives each of the filter criteria and creates a Smart Chat or event that is only accessible by user accounts with profile elements matching the filter criteria.

Filter criteria include a budget, age, occupation, school, gender, fan type, group associations, interests, previous activities, date, time, location, mutual connections, etc. In one embodiment, a fan type filter allows for filtration of event attendees to those who have purchased tickets or joined an event page via a particular portal, Smart Chat, promotional code, etc. For example, a user account that purchases tickets through a NEW YORK METS web portal is tagged with a METS indicator, which is a filterable criterion through the filter page. In another embodiment, a user account is operable to include a profile element indicating a fan association (e.g., a fan of the NEW YORK YANKEES).

In one embodiment, the Platform is operable to determine and communicate to at least one user account an indication of users associated with a specific event or venue, including generating and sending an alert to at least one user account with event attendees and statistics. For example, the Platform is operable to indicate on an event page a ratio of guys and girls interested in the event or committed to the event (e.g. “70% of users attending are male”). In another embodiment, the statistics are based on a comparison of a user account profile and profiles of attending users. For example, the Platform is operable to determine and communicate to the user account, “45% of users attending have similar profiles to yours.” Statistics are determined, in one embodiment, based on user accounts associated with the event on the Platform. In another embodiment, user accounts are associated with the event automatically based on a determined location of a device associated with the user account. For example, the Platform receives a geographic coordinate of at least one device associated with a user account, determines that the geographic coordinate is within a specific venue, and automatically adds the user account to an event or Smart Chat associated with the venue. Upon determining statistics for an event or venue, the Platform is operable to retrieve profile elements of the automatically added user accounts. The Platform is further operable to assign visual indicators to user profiles based on profile elements associated with user accounts. Visual indicators include color, symbols, text, or other differentiating marks. For example, in one embodiment, user accounts associated with an event that have indicated attending for business are assigned a blue visual indicator on an event attendee page and user accounts that have indicated a desire to attend with other user accounts are assigned a yellow visual indicator. In one embodiment, interacting with interactive elements, including artificial intelligence operations of the Platform, adjusts visual elements of the Smart Chat, including changing a color of the Smart Chat or providing a symbol, text, or other differentiating mark that indicates that artificial intelligence or external services are enabled.

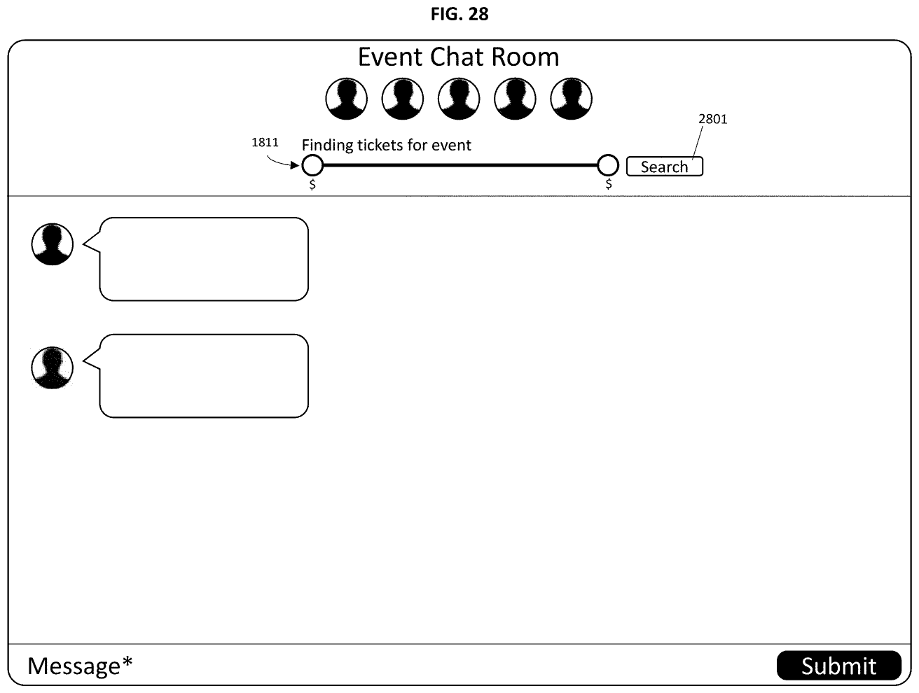

FIG. 28 illustrates a Smart Chat with a search button 2801. In one embodiment, the Platform is operable to receive a preferred price range from the slider bar 1811, and, upon receiving an interaction with the search button 2801, the Platform is operable to search for tickets or reservations that match the preferred price range and/or other search preferences for the attached event.

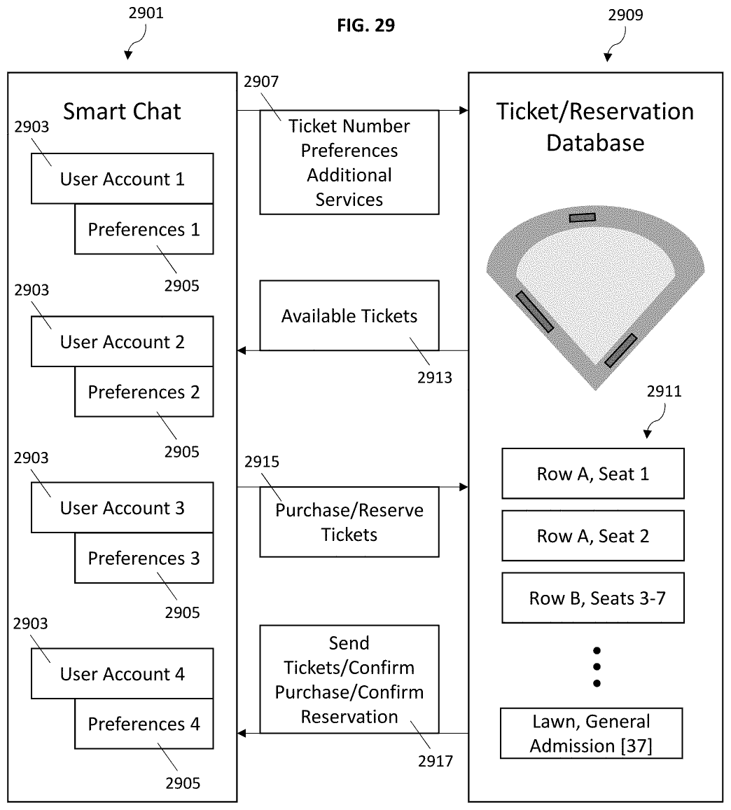

FIG. 29 illustrates a ticket purchase and/or reservation system according to one embodiment of the present invention. A Smart Chat 2901 includes at least four user accounts 2903, wherein each user account identifies preferences 2905 for a ticket purchase or reservation. In one embodiment, the Smart Chat 2901 and/or Platform queries 2907 a ticket/reservation database 2909 for tickets matching a number of Smart Chat user accounts 2905, a number of requested tickets, and tickets that meet each of the preferences 2905. The ticket/reservation database 2909 is either an external server accessed by the Platform or it is an internal listing of tickets managed by the Platform directly. The Platform and Smart Chat 2901 are operable to receive or retrieve from the ticket/reservation database 2909 a listing of available tickets that match each of the preferences submitted via a query response 2913. The listing of tickets is selected from a store of available tickets 2911 stored on the ticket/reservation database 2909. In one embodiment, the tickets are not from a single block or listing of tickets. Instead, a query response 2913 includes a list of tickets pieced from two or more blocks or listings. Upon the Smart Chat 2901 receiving all necessary preferences, confirmations, and payment methods required for purchase or reservation, the Smart Chat 2901 or Platform then sends a second query 2915 to purchase and/or reserve the tickets. The ticket/reservation database 2909 returns in a query response 2917 the tickets, a redemption code, a barcode, a confirmation of purchase, a confirmation of reservation, or any other digital object tied to the ticket or reservation. In one embodiment, the Smart Chat 2909 or Platform is operable to query multiple internal and external databases in network communication with the Platform to fulfil the ticket preferences and requests.

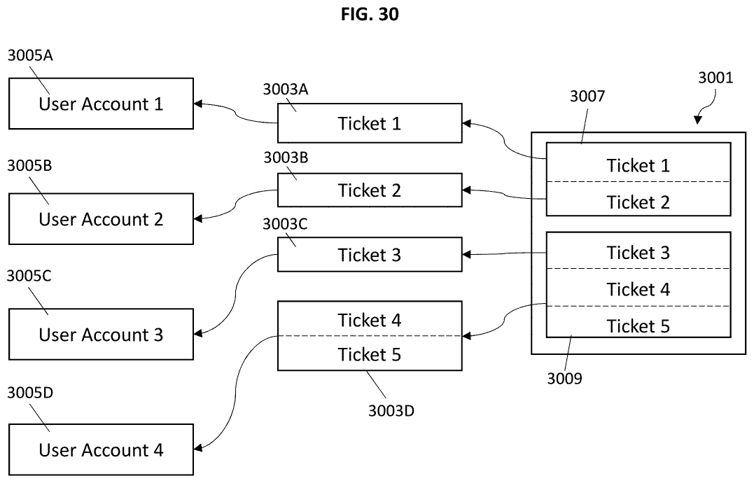

FIG. 30 illustrates one embodiment of a multi-ticket purchasing embodiment. A purchased group of tickets 3001 includes two different purchased ticket blocks 3007, 3009. Upon receiving the purchased group of tickets 3001, the Platform is operable to separate each of the tickets and deliver each ticket to a corresponding user account 2903 based on user preferences. For example, in the illustrated embodiment, the block of two tickets 3007 is divided into Ticket 1 3003A and Ticket 2 3003B and delivered to User Account 1 3005A and User Account 2 3005B, respectfully. The block of three tickets 3009 is divided into Ticket 3 3003C and a pair of Ticket 4 and Ticket 5 3003D. Ticket 3 is delivered to User Account 3 3005C and Ticket 4 and Ticket 5 3003D are delivered to User Account 4 3005D, wherein preferences submitted by User Account 4 in a Smart Chat or user profile include a request for at least two tickets. Preferably, the tickets are each associated with, attached to, and/or added to a database or profile for each user account.

The above-mentioned examples are provided to serve the purpose of clarifying the aspects of the invention, and it will be apparent to one skilled in the art that they do not serve to limit the scope of the invention. The above-mentioned examples are just some of the many configurations that the mentioned components can take on. All modifications and improvements have been deleted herein for the sake of conciseness and readability but are properly within the scope of the present invention.

What it claimed is:

1. A system for coordinating event communication and ticketing, comprising:
at least one server computer, including a memory with at least one database;
an internet messaging platform; and
wherein the at least one server computer is operable to manage an internal database of tickets in the at least one database or an external database of tickets;
wherein the at least one server computer is in network communication with a plurality of devices;
wherein the at least one server computer is operable to receive and store a plurality of user profiles;
wherein the at least one server computer is operable to provide to the plurality of devices at least one interactive user interface having an indication of upcoming live events;
wherein the at least one server computer is operable to establish a group communication connection between a subset of the plurality of user profiles via the internet messaging platform;
wherein the internet messaging platform is operable to assign an event to the group communication connection;
wherein the internet messaging platform is operable to receive predetermined price ranges from the subset of the plurality of user profiles via the group communication connection;
wherein the at least one server computer is operable to determine an available selection of tickets for the assigned event based on the desired price ranges;
wherein the at least one server computer is operable to reserve and/or purchase the available selection of tickets;
wherein the at least one server computer is operable to, upon reservation or purchase of the available selection of tickets, assign the tickets to the subset of the plurality of user profiles; and
wherein the at least one server computer is operable to, upon assignment of the tickets to the subset of the plurality of user profiles, provide access to a second internet messaging platform for each of the subset of the plurality of user profiles.

2. The system of claim 1, wherein the at least one server computer is operable to reserve or purchase the available selection of tickets upon receiving payment information and/or a confirmation from each of the subset of the plurality of user profiles.

3. The system of claim 1, wherein the internet messaging platform enforces a set time limit for supplying payment information and/or confirmation from each of the subset of the plurality of user profiles before the ticketing retrieval service reserves and/or purchases the available selection of tickets.

4. The system of claim 3, wherein the set time limit is 24 hours.

5. The system of claim 1, wherein the second internet messaging platform is restricted to user profiles associated with purchased tickets to the assigned event.

6. The system of claim 1, wherein the second internet messaging platform is in network communication with at least one external service associated with the assigned event, including vendor systems associated with a locality of the assigned event.

7. The system of claim 1, wherein the second internet messaging platform is operable to receive media elements and store the media elements in the at least one server, wherein the at least one server computer is operable to publicly associate the second internet messaging platform with each of the plurality of user profiles having access.

8. A method for coordinating event communication and ticketing, comprising:
providing at least one server in network communication with a plurality of devices;
storing a plurality of user profiles on the at least one server;
providing to the plurality of devices an indication of upcoming live events;
establishing a group communication connection between a subset of the plurality of user profiles via an internet messaging platform;
assigning an event to the group communication connection;
receiving desired price ranges from the subset of the plurality of user profiles via the group communication connection;
determining an available selection of tickets for the assigned event based on the predetermined price ranges; and
reserving and/or purchasing the available selection of tickets.

9. The method of claim 8, further comprising receiving payment account information from each of the subset of the plurality of user profiles and charging each of the payment accounts according to an individual number of tickets requested by each of the subset of the plurality of user profiles.

10. The method of claim 9, further comprising purchasing the available selection of tickets as a block and charging each of the payment accounts for the individual number of tickets requested by each of the subset of the plurality of user profiles.

11. The method of claim 9, wherein reserving or purchasing the available selection of tickets includes transmitting the payment account information to an external ticketing system.

12. The method of claim 8, further comprising reserving or purchasing the available selection of tickets upon receiving payment account information and/or a confirmation from each of the subset of the plurality of user profiles.

13. The method of claim 8, further comprising:
determining events relevant to at least one of the plurality of user profiles using a machine learning model, wherein the machine learning model is trained with data relating to at least the reserving and/or the purchasing;
wherein the indication of upcoming live events includes the events relevant to the at least one of the plurality of user profiles.

14. A system for coordinating event communication and ticketing, comprising:
at least one server computer, including a memory with at least one database;
an internet messaging platform; and
wherein the at least one server computer is in network communication with a plurality of devices;
wherein the at least one server computer is operable to store a plurality of user profiles;
wherein the at least one server computer is operable to provide to the plurality of devices an indication of upcoming live events;
wherein the at least one server computer is operable to establish a group communication connection between a subset of the plurality of user profiles via the internet messaging platform;
wherein the internet messaging platform is operable to assign an event to the group communication connection;
wherein the internet messaging platform is operable to receive desired price ranges from the subset of the plurality of user profiles via the group communication connection;
wherein at least one server computer is operable to determine an available selection of tickets for the assigned event based on the predetermined price ranges; and
wherein the at least one server computer is operable to reserve and/or purchase the available selection of tickets.

15. The system of claim 14, wherein the at least one server computer is operable to receive payment account information from each of the subset of the plurality of user profiles and charge each of the payment accounts according to an individual number of tickets requested by each of the subset of the plurality of user profiles.

16. The system of claim 15, wherein the at least one server computer is operable to initially purchase the available selection of tickets as a set and, following the initial purchase, charge each of the payment accounts for the individual number of tickets requested by each of the subset of the plurality of user profiles.

17. The system of claim 15, wherein the at least one server computer is operable to reserve or purchase the available selection of tickets by transmitting the payment account information to an external ticketing system.

18. The system of claim 14, wherein the at least one server computer is operable to select the subset of the plurality of user profiles based on mutual indications of profile interest received from each of at least two of the plurality of user profiles.

19. The system of claim 14, wherein the at least one server is operable to restrict establishment of the group communication connection based on at least one profile element requirement.

20. The system of claim 19, wherein the at least one server computer is operable to assign at least two events to the group communication connection, wherein the at least one server is operable to create a reservation and/or purchase tickets based on preferences from the subset of the plurality of user profiles.
